(19) United States
(12) Patent Application Publication
(10) Pub. No.: US 2023/0120491 A1
(43) Pub. Date: Apr. 20, 2023

(54) MANUFACTURING METHODS FOR SHEET FOR ALL-SOLID STATE SECONDARY BATTERY AND ALL-SOLID STATE SECONDARY BATTERY, AND SHEET FOR ALL-SOLID STATE SECONDARY BATTERY AND ALL-SOLID STATE SECONDARY BATTERY

(71) Applicant: FUJIFILM Corporation, Tokyo (JP)

(72) Inventors: Hiroshi Isojima, Kanagawa (JP); Hideyuki Suzuki, Kanagawa (JP)

(73) Assignee: FUJIFILM Corporation, Tokyo (JP)

(21) Appl. No.: 18/068,500

(22) Filed: Dec. 19, 2022

Related U.S. Application Data
(63) Continuation of application No. PCT/JP2021/025169, filed on Jul. 2, 2021.

(30) Foreign Application Priority Data
Jul. 2, 2020 (JP) 2020-114680

(51) Int. Cl. H01M 4/04; H01M 4/62

(52) U.S. Cl. CPC H01M 4/0407; H01M 4/0471; H01M 4/622; H01M 2300/0068

(57) ABSTRACT

There is provided a manufacturing method for a sheet for an all-solid state secondary battery, including subjecting an inorganic solid electrolyte-containing composition containing an inorganic solid electrolyte and a dispersion medium to application and film formation onto a base material, in which in the inorganic solid electrolyte-containing composition, any one or both of a preparation temperature and a temperature before the application and the film formation is set to 35° C. to 90° C. There are also provided a manufacturing method for an all-solid state secondary battery, which carries out manufacture through this manufacturing method, a sheet for an all-solid state secondary battery, and an all-solid state secondary battery.

This application is a Continuation of PCT International Application No. PCT/JP2021/025169 filed on Jul. 2, 2021, which claims priority under 35 U.S.C. § 119 (a) to Japanese Patent Application No. 2020-114680 filed in Japan on Jul. 2, 2020. Each of the above applications is hereby expressly incorporated by reference, in its entirety, into the present application.

### BACKGROUND OF THE INVENTION

### 1. Field of the Invention

The present invention relates to manufacturing methods for a sheet for an all-solid state secondary battery and an all-solid state secondary battery and relates to a sheet for all-solid state secondary battery and an all-solid state secondary battery.

### 2. Description of the Background Art

In an all-solid state secondary battery, all of a negative electrode, an electrolyte, and a positive electrode consist of solid, and the all-solid state secondary battery can greatly improve safety and reliability, which are said to be problems to be solved in a battery in which an organic electrolytic solution is used. It is also said to be capable of extending the battery life. Furthermore, all-solid state secondary batteries can be provided with a structure in which the electrodes and the electrolyte are directly disposed in series. As a result, it becomes possible to increase the energy density to be high as compared with a secondary battery in which an organic electrolytic solution is used, and thus the application to electric vehicles, large-sized storage batteries, and the like is anticipated.

In such an all-solid state secondary battery, as substances that form constitutional layers (a solid electrolyte layer, a negative electrode active material layer, a positive electrode active material layer, and the like), an inorganic solid electrolyte, an active material, and the like are used. In recent years, this inorganic solid electrolyte, particularly an oxide-based inorganic solid electrolyte or a sulfide-based inorganic solid electrolyte is expected as an electrolyte material having a high ion conductivity comparable to that of the organic electrolytic solution.

As the material that forms a constitutional layer (a constitutional layer forming material) of an all-solid state secondary battery, a composition containing the above-described inorganic solid electrolyte and the like and containing a dispersion medium and the like has been proposed, and a method of forming a constitutional layer using this composition has also been proposed. For example, JP2010-186682A discloses a manufacturing method for a solid electrolyte layer. Specifically, this manufacturing method includes a step of preparing a solid electrolyte layer forming slurry by mixing a sulfide-based solid electrolyte material and a binding agent polymer having a double bond and capable of bonding to a sulfur component to obtain a solid electrolyte layer forming slurry; and a bonding treatment step of bonding the sulfur component in the sulfide-based solid electrolyte material and the double bond of the binding agent polymer by subjecting the solid electrolyte layer forming slurry to a bonding treatment.

### SUMMARY OF THE INVENTION

In a case of forming a constitutional layer with solid particle materials (an inorganic solid electrolyte, an active material, conductive auxiliary agent, and the like), it is desirable that the constitutional layer forming material is excellent in characteristics such as dispersibility and ease of handling from the viewpoint of improving the battery performance (for example, cycle characteristics) of an all-solid state secondary battery.

From the viewpoints of reducing the burden on the environment in recent years and reducing the manufacturing cost, the use of a high-concentration composition (a concentrated slurry) having an increased solid content concentration has been studied as a constitutional layer forming material. However, as the solid content concentration of the composition is increased, the characteristics of the composition generally deteriorate significantly. As a result, in the high-concentration composition, it is not easy to realize the characteristics required for the constitutional layer forming material, and there is room for further study.

Further, research and development for improving the performance and the practical application of electric vehicles have progressed rapidly, and the demand for battery performance required for an all-solid state secondary battery has become higher. In order to respond to such demands, it is important to make the constitutional layer forming material exhibit higher characteristics to form a constitutional layer.

However, the manufacturing method disclosed in JP2010-186682A is a method of heating a slurry after application to chemically bonding a sulfide-based solid electrolyte material to a binding agent polymer, thereby manufacturing a solid electrolyte layer, a study has not been made from the viewpoint of improving the characteristics of the slurry to form a solid electrolyte layer.

An object of the present invention is to provide a manufacturing method for a sheet for an all-solid state secondary battery, which is capable of improving the cycle characteristics of the all-solid state secondary battery, even in a case where an inorganic solid electrolyte-containing composition having an increased solid content concentration is used, and a manufacturing method for an all-solid state secondary battery that realizes excellent cycle characteristics. In addition, an object of the present invention is to provide a sheet for an all-solid state secondary battery and an all-solid state secondary battery, respectively manufactured by the above-described manufacturing methods.

As a result of repeated studies on an inorganic solid electrolyte-containing composition used for manufacturing a sheet for an all-solid state secondary battery, the inventors of the present invention found that the temperature (the preparation temperature) at the time of preparation of the inorganic solid electrolyte-containing composition (the slurry) is significantly associated with the dispersion characteristics of suppressing aggregation and the like of a solid particle material (also referred to as a solid particle), and furthermore, that the temperature of the slurry-shaped inorganic solid electrolyte-containing composition used for the application and film formation (the temperature before application and film formation) is significantly associated with the characteristics (the stable application suitability) of imparting a proper viscosity to the slurry and exhibiting high fluidity so that solid particles in the constitutional layer are intimately attached on the base material and that as a result, there is an effect of improving the cycle characteristics of the all-solid state secondary battery. As a result of further studies based on these findings, it was found that regarding an inorganic solid electrolyte-containing inorganic solid electrolyte-containing composition and a dispersion medium, in a case where any one or both of the preparation temperature of the composition and the temperature thereof before application and film formation is set to 35° C. to 90° C., excellent dispersion characteristics and excellent application suitability can be exhibited even in a case where the solid content concentration is increased. The present invention has been completed through further studies based on these findings.

That is, the above problems have been solved by the following means.

<1> A manufacturing method for a sheet for an all-solid state secondary battery, comprising:

subjecting an inorganic solid electrolyte-containing composition containing an inorganic solid electrolyte having an ion conductivity of a metal belonging to Group 1 or Group 2 in the periodic table and a dispersion medium, to application and film formation onto a base material,

in which in the inorganic solid electrolyte-containing composition, any one or both of a preparation temperature and a temperature before the application and the film formation is set to 35° C. to 90° C.

<2> The manufacturing method for a sheet for an all-solid state secondary battery according to <1>, in which both of the preparation temperature and the temperature before the application and the film formation are set to 35° C. to 90° C.

<3> The manufacturing method for a sheet for an all-solid state secondary battery according to <1> or <2>, in which the inorganic solid electrolyte-containing composition has a viscosity of 500 to 10,000 cP at 25° C.

<4> The manufacturing method for a sheet for an all-solid state secondary battery according to any one of <1> to <3>, in which in the inorganic solid electrolyte-containing composition, a difference (in terms of absolute value) between the viscosity at 25° C. and a viscosity at a higher temperature among the preparation temperature and the temperature before the application and the film formation is 1,000 cP or more.

<5> The manufacturing method for a sheet for an all-solid state secondary battery according to any one of <1> to <4>, in which the dispersion medium has a boiling point of 100° C. to 250° C.

<6> The manufacturing method for a sheet for an all-solid state secondary battery according to any one of <1> to <5>, in which the inorganic solid electrolyte-containing composition contains a binder.

<7> The manufacturing method for a sheet for an all-solid state secondary battery according to any one of <1> to <6>, in which the inorganic solid electrolyte-containing composition contains an active material.

<8> A manufacturing method for an all-solid state secondary battery which has a positive electrode active material layer, a solid electrolyte layer, and a negative electrode active material layer in this order, the manufacturing method for an all-solid state secondary battery, comprising:

a step of manufacturing at least one layer of the positive electrode active material layer, the solid electrolyte layer, or the negative electrode active material layer by the manufacturing method for a sheet for an all-solid state secondary battery according to any one of <1> to <7>.

<9> The manufacturing method for an all-solid state secondary battery according to <8> which has a collector laminated on a side each of the positive electrode active material layer and the negative electrode active material layer, opposite to the solid electrolyte layer, the manufacturing method for all-solid state secondary battery, comprising:

a step of manufacturing at least one of a positive electrode in which the collector and the positive electrode active material layer are laminated, the solid electrolyte layer, or a negative electrode in which the collector and the negative electrode active material layer are laminated, through the manufacturing method for a sheet for an all-solid state secondary battery according to any one of <1> to <7>.

<10> A sheet for an all-solid state secondary battery, which is manufactured according to the manufacturing method for a sheet for an all-solid state secondary battery according to any one of <1> to <7>.

<11> An all-solid state secondary battery comprising, in the following order:

a positive electrode active material layer;

a solid electrolyte layer; and

a negative electrode active material layer,

in which at least one layer of the positive electrode active material layer, the solid electrolyte layer, or the negative electrode active material layer is composed of the sheet for an all-solid state secondary battery according to <10>.

<12> The all-solid state secondary battery according to <11>, further comprising:

a collector laminated on a side each of the positive electrode active material layer and the negative electrode active material layer, opposite to the solid electrolyte layer,

in which at least one of a positive electrode in which the collector and the positive electrode active material layer are laminated, the solid electrolyte layer, or a negative electrode in which the collector and the negative electrode active material layer are laminated is composed of the sheet for an all-solid state secondary battery according to <10>.

According to the manufacturing method for a sheet for an all-solid state secondary battery according to the aspect of the present invention, it is possible to manufacture a sheet for an all-solid state secondary battery, which is capable of improving the cycle characteristics of the all-solid state secondary battery, even in a case of using an inorganic solid electrolyte-containing composition having an increased solid content concentration. In addition, according to the manufacturing method for an all-solid state secondary battery according to the aspect of the present invention, it is possible to manufacture an excellent all-solid state secondary battery, even in a case of using an inorganic solid electrolyte-containing composition having an increased solid content concentration.

Furthermore, according to the sheet for an all-solid state secondary battery according to the aspect of the present invention, it is possible to improve the cycle characteristics of an all-solid state secondary battery by incorporating the sheet for an all-solid state secondary battery into the all-solid state secondary battery as a constitutional layer. In addition, it is possible for the all-solid state secondary battery according to the aspect of the present invention to realize excellent cycle characteristics.

The above-described and other characteristics and advantages of the present invention will be further clarified by the following description with appropriate reference to the accompanying drawing.

### BRIEF DESCRIPTION OF THE DRAWINGS

FIG. 1 is a vertical cross-sectional view schematically illustrating an all-solid state secondary battery according to a preferred embodiment of the present invention.

### DESCRIPTION OF THE PREFERRED EMBODIMENTS

In the present invention, a numerical range indicated using “to” means a range including numerical values before and after the “to” as the lower limit value and the upper limit value.

In the present invention, the expression of a compound (for example, in a case where a compound is represented by an expression in which “compound” is attached to the end) refers to not only the compound itself but also a salt or an ion thereof. In addition, this expression also refers to a derivative obtained by modifying a part of the compound, for example, by introducing a substituent into the compound within a range where the effect of the present invention is not impaired.

In the present invention, (meth)acryl means one or both of acryl and methacryl. The same applies to (meth)acrylate.

First, a sheet for an all-solid state secondary battery and an all-solid state secondary battery, which are respectively manufactured by applying a manufacturing method for a sheet for an all-solid state secondary battery according to an embodiment of the present invention and a manufacturing method for an all-solid state secondary battery according to an embodiment of the present invention (these may also be referred to as a manufacturing method according to the embodiment of the present invention), will be described.

[Sheet for all-Solid State Secondary Battery]

A sheet for an all-solid state secondary battery according to the embodiment of the present invention is a sheet-shaped molded body with which a constitutional layer of an all-solid state secondary battery can be formed, and it includes various aspects depending on use applications thereof. Examples of thereof include a sheet that is preferably used in a solid electrolyte layer (also referred to as a solid electrolyte sheet for an all-solid state secondary battery) and a sheet that is preferably used in an electrode or a laminate of an electrode and a solid electrolyte layer (an electrode sheet for an all-solid state secondary battery). In the present invention, the variety of sheets described above will be collectively referred to as a sheet for an all-solid state secondary battery.

In the present invention, each layer constituting a sheet for an all-solid state secondary battery may have a monolayer structure or a multilayer structure.

In the sheet for an all-solid state secondary battery according to the embodiment of the present invention, a solid electrolyte layer or an active material layer on a base material is formed by the manufacturing method for a sheet for an all-solid state secondary battery according to the embodiment of the present invention. As a result, the sheet for an all-solid state secondary battery according to the embodiment of the present invention can improve cycle characteristics of an all-solid state secondary battery in a case where it is used as a solid electrolyte layer, an active material layer, or an electrode of an all-solid secondary battery by appropriately peeling off a base material therefrom. In particular, in a case where an electrode sheet for an all-solid state secondary battery is incorporated into an all-solid state secondary battery as an electrode, the cycle characteristics can be further improved since an active material layer and a collector are firmly adhered to each other.

Although the details of the reason why the sheet for an all-solid state secondary battery according to the embodiment of the present invention can improve the cycle characteristics of the all-solid state secondary battery have not been revealed yet, it is conceived to be because it is possible to realize excellent dispersion characteristics and excellent application suitability in an inorganic solid electrolyte-containing composition that is used in the manufacturing method for a sheet for an all-solid state secondary battery according to the embodiment of the present invention.

In a case of preparing an inorganic solid electrolyte-containing composition that is used in the manufacturing method for a sheet for an all-solid state secondary battery according to the embodiment of the present invention by mixing (dispersing) each component at a preparation temperature of 30° C. to 95° C., it is conceived that the interaction between solid particles can be weakened to suppress aggregation or sedimentation of the solid particles. As a result, the dispersibility of the solid particles in the composition can be enhanced, and a highly dispersed state can be stably maintained even after a lapse of time. In a case of forming a constitutional layer by using such an inorganic solid electrolyte-containing composition that exhibits excellent dispersion characteristics, it is possible to form a constitutional layer in which solid particles are uniformly disposed and bound with few aggregates of the solid particles. As a result, it is possible to suppress the generation or expansion of voids due to charging and discharging, which contributes to the improvement of cycle characteristics of an all-solid state secondary battery.

On the other hand, in a case of preheating an inorganic solid electrolyte-containing composition to be used to 30° C. to 95° C. before applying it and forming a film thereof (also simply referred to as film formation), it is conceived that the interaction between the solid particles is effectively weakened, and thus it is possible for the inorganic solid electrolyte-containing composition immediately before film formation to exhibit a viscosity (fluidity) suitable for film formation in addition to improving the dispersion characteristics. As a result, the applied inorganic solid electrolyte-containing composition properly flows (becomes leveled), and the generation of protrusions and recesses having severe undulations due to insufficient flow or excessive flow can be suppressed (the surface properties of the coated surface are excellent). Furthermore, the interfacial contact state of the solid particles is improved, and thus the solid particles are firmly attached intimately.

In particular, according to the present invention, even in a case where the solid content concentration of the inorganic solid electrolyte-containing composition is set to be higher than that in the related art, the above-described effect obtained by setting one or both of the preparation temperature and the temperature before the application and film formation to the above-described temperature can be exhibited without being impaired, and the above-described excellent dispersion characteristics and application suitability can be realized.

In a case where a constitutional layer is formed by using such an inorganic solid electrolyte-containing composition having excellent dispersion characteristics and excellent application suitability, the adhesiveness between solid particles as well as the adhesiveness between solid particles and a base material (a collector) is enhanced while suppressing the generation of voids due to the improvement of the dispersion characteristics, and furthermore, the concentration of current (the deterioration of solid particles) on steep protruding parts on the surface of the constitutional layer can be suppressed. As a result, the cycle characteristics of the all-solid state secondary battery can be improved.

<Solid Electrolyte Sheet for all-Solid State Secondary Battery>

It suffices that the solid electrolyte sheet for an all-solid state secondary battery according to the embodiment of the present invention is a sheet having a solid electrolyte layer, and examples of the solid electrolyte sheet for an all-solid state secondary battery include a sheet that does not have a base material and is formed from a solid electrolyte layer (a sheet from which a base material has been peeled off), a laminated sheet in which a solid electrolyte layer is formed on a base material, and a laminated sheet having a solid electrolyte layer and a protective layer in this order on a base material. The solid electrolyte sheet for an all-solid state secondary battery may include another layer other than the solid electrolyte layer. Examples of the other layer include a protective layer (a stripping sheet), a collector, and a coating layer.

The solid electrolyte layer included in the solid electrolyte sheet for an all-solid state secondary battery is formed by the manufacturing method for a sheet for an all-solid state secondary battery according to the embodiment of the present invention.

The surface state of the solid electrolyte layer is appropriately determined in consideration of the ion conductivity, the adhesiveness to a layer provided on the surface, and the like. However, in a case where the protrusions and recesses of the surface are too large, the current is concentrated at steep protruding parts to deteriorate the solid particles, which causes the deterioration of the cycle characteristics of the all-solid state secondary battery. As a result, from the viewpoint of cycle characteristics, it is preferable that the surface of the solid electrolyte layer is flat (smooth) (with few steep protruding parts). For example, the maximum height roughness Rz thereof is preferably less than 10 μm, more preferably 8.0 μm or less, and still more preferably 6.0 μm or less. The lower limit of the maximum height roughness Rz is not particularly limited, and it is practically set to, for example, 0.5 μm or more. The maximum height roughness Rz of the solid electrolyte layer is a value calculated according to the method described in Examples.

In addition, in the solid electrolyte layer, the adhesiveness between the solid particles is firm, and the hardness of the layer itself is also high.

The contents of the respective components in the solid electrolyte layer are not particularly limited; however, the contents are preferably the same as the contents of the respective components with respect to the solid content of the inorganic solid electrolyte-containing composition described later. The layer thickness of each layer that constitutes the solid electrolyte sheet for an all-solid state secondary battery is the same as the layer thickness of each layer described later in the all-solid state secondary battery.

The base material is not particularly limited as long as it can support the solid electrolyte layer, and examples thereof include a sheet body (plate-shaped body) formed of materials described later regarding the collector, an organic material, an inorganic material, or the like. Examples of the organic material include various polymers, and specific examples thereof include polyethylene terephthalate, polypropylene, polyethylene, and cellulose. Examples of the inorganic material include glass and ceramic.

<Electrode Sheet for all-Solid State Secondary Battery>

It suffices that the electrode sheet for an all-solid state secondary battery (also simply referred to as an “electrode sheet”) according to the embodiment of the present invention is a sheet having an active material layer. However, the electrode sheet for an all-solid state secondary battery is generally a sheet having a collector and an active material layer. Examples of the solid electrolyte sheet for an all-solid state secondary battery include a sheet that does not have a base material and is formed from an active material layer (a sheet from which a base material has been peeled off), a laminated sheet in which an active material layer is formed on a base material (a collector), a laminated sheet in which an active material layer and a solid electrolyte layer are formed in this order on a base material, and a laminated sheet in which an active material layer, a solid electrolyte layer, and an active material layer are formed in this order on a base material. The electrode sheet according to the embodiment of the present invention may include the above-described other layer.

It is preferable that the active material layer that is formed on the base material is formed by the manufacturing method for a sheet for an all-solid state secondary battery according to the embodiment of the present invention and the solid electrolyte layer that is formed on the active material layer is formed by the manufacturing method for a sheet for an all-solid state secondary battery according to the embodiment of the present invention.

The surface states of the active material layer and the solid electrolyte layer, which are formed by the manufacturing method for a sheet for an all-solid state secondary battery according to the embodiment of the present invention, and the adhesiveness of the solid particles are the same as the surface state of the above-described solid electrolyte layer. In addition, the active material layer formed on the base material also exhibits firm adhesiveness to the collector in addition to the adhesiveness of the solid particles. It is conceived to be because the interfacial contact state between the solid particles and the surface of the collector is improved.

In the electrode sheet, the contents of the respective components in this solid electrolyte layer or active material layer are not particularly limited; however, the contents are preferably the same as the contents of the respective components with respect to the solid content of the inorganic solid electrolyte-containing composition (the electrode composition) described later. The thickness of each of the layers forming the electrode sheet according to the embodiment of the present invention is the same as the layer thickness of each of the layers described later regarding the all-solid state secondary battery.

It is noted that in a case where the sheet for an all-solid state secondary battery has a layer other than the active material layer or the solid electrolyte layer, which is formed by the manufacturing method for a sheet for an all-solid state secondary battery according to the embodiment of the present invention, a layer manufactured according to a conventional method using known materials can be used as this layer.

[All-Solid State Secondary Battery]

The all-solid state secondary battery according to the embodiment of the present invention includes a positive electrode active material layer, a negative electrode active material layer facing the positive electrode active material layer, and a solid electrolyte layer disposed between the positive electrode active material layer and the negative electrode active material layer. The all-solid state secondary battery according to the embodiment of the present invention is not particularly limited in the configuration as long as it has a solid electrolyte layer between the positive electrode active material layer and the negative electrode active material layer, and for example, a known configuration for an all-solid state secondary battery can be employed. In a preferred all-solid state secondary battery, a positive electrode collector is laminated on a surface of the positive electrode active material layer opposite to the solid electrolyte layer to constitute a positive electrode, and a negative electrode collector is laminated on a surface of the negative electrode active material layer opposite to the solid electrolyte layer to constitute a negative electrode. In the present invention, each constitutional layer (including a collector and the like) constituting an all-solid state secondary battery may have a monolayer structure or a multilayer structure.

In the all-solid state secondary battery according to the embodiment of the present invention, at least one of the negative electrode active material layer (the negative electrode), the positive electrode active material layer (the positive electrode), or the solid electrolyte layer is composed of the sheet for an all-solid state secondary battery, which is formed by the manufacturing method for a sheet for an all-solid state secondary battery according to the embodiment of the present invention. One of preferred aspects of the all-solid state secondary battery is an aspect in which all of the negative electrode active material layer (the negative electrode), the positive electrode active material layer (the positive electrode), and the solid electrolyte layer are composed of the sheet for an all-solid state secondary battery, which is formed by the manufacturing method for a sheet for an all-solid state secondary battery according to the embodiment of the present invention.

In the all-solid state secondary battery according to the embodiment of the present invention, the sheet for an all-solid state secondary battery, formed by the manufacturing method for a sheet for an all-solid state secondary battery according to the embodiment of the present invention, is incorporated as at least one constitutional layer. As a result, the all-solid state secondary battery according to the embodiment of the present invention exhibits excellent cycle characteristics.

<Active Material Layer and Solid Electrolyte Layer>

Details of the active material layer and the solid electrolyte layer, which are formed of the sheet for an all-solid state secondary battery formed by the manufacturing method for a sheet for an all-solid state secondary battery according to the embodiment of the present invention, will be described later.

The thickness of each of the negative electrode active material layer, the solid electrolyte layer, and the positive electrode active material layer is not particularly limited. In case of taking a dimension of a general all-solid state secondary battery into account, the thickness of each of the layers is preferably 10 to 1,000 μm and more preferably 20 μm or more and less than 500 μm. In the all-solid state secondary battery according to the embodiment of the present invention, the thickness of at least one layer of the positive electrode active material layer or the negative electrode active material layer is still more preferably 50 μm or more and less than 500 μm.

It is noted that in a case where the active material layer or the solid electrolyte layer is not composed of the sheet for an all-solid state secondary battery, formed by the manufacturing method for a sheet for an all-solid state secondary battery according to the embodiment of the present invention, a layer manufactured according to a conventional method using known materials can be used as this layer.

<Collector>

The positive electrode collector and the negative electrode collector are preferably an electron conductor.

In the present invention, either or both of the positive electrode collector and the negative electrode collector will also be simply referred to as the collector.

As a material that forms the positive electrode collector, not only aluminum, an aluminum alloy, stainless steel, nickel, or titanium but also a material (a material on which a thin film has been formed) obtained by treating the surface of aluminum or stainless steel with carbon, nickel, titanium, or silver is preferable. Among these, aluminum or an aluminum alloy is more preferable.

As a material that forms the negative electrode collector, aluminum, copper, a copper alloy, stainless steel, nickel, titanium, or the like, and further, a material obtained by treating the surface of aluminum, copper, a copper alloy, or stainless steel with carbon, nickel, titanium, or silver is preferable, and aluminum, copper, a copper alloy, or stainless steel is more preferable.

Regarding the shape of the collector, a film sheet shape is typically used; however, it is also possible to use shapes such as a net shape, a punched shape, a lath body, a porous body, a foaming body, and a molded body of a fiber group.

The thickness of the collector is not particularly limited; however, it is preferably 1 to 500 μm. In addition, protrusions and recesses are preferably provided on the surface of the collector by carrying out a surface treatment.

<Other Configurations>

In the present invention, a functional layer, a functional member, or the like may be appropriately interposed or disposed between or on the outside of the respective layers of the negative electrode collector, the negative electrode active material layer, the solid electrolyte layer, the positive electrode active material layer, and the positive electrode collector.

<Housing>

Depending on the use application, the all-solid state secondary battery according to the embodiment of the present invention may be used as the all-solid state secondary battery having the above-described structure as it is but is preferably sealed in an appropriate housing to be used in the form of a dry cell. The housing may be a metallic housing or a resin (plastic) housing. In a case where a metallic housing is used, examples thereof include an aluminum alloy housing and a stainless steel housing. It is preferable that the metallic housing is classified into a positive electrode-side housing and a negative electrode-side housing and that the positive electrode-side housing and the negative electrode-side housing are electrically connected to the positive electrode collector and the negative electrode collector, respectively. The positive electrode-side housing and the negative electrode-side housing are preferably integrated by being joined together through a gasket for short circuit prevention.

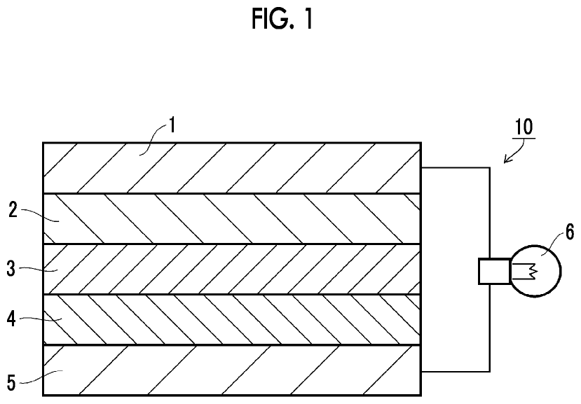

Hereinafter, the all-solid state secondary battery according to the preferred embodiments of the present invention will be described with reference to FIG. 1; however, the present invention is not limited thereto.

FIG. 1 is a cross-sectional view schematically illustrating an all-solid state secondary battery (a lithium ion secondary battery) according to a preferred embodiment of the present invention. In a case of being seen from the negative electrode side, an all-solid state secondary battery 10 of the present embodiment includes a negative electrode collector 1, a negative electrode active material layer 2, a solid electrolyte layer 3, a positive electrode active material layer 4, and a positive electrode collector 5 in this order. The respective layers are in contact with each other, and thus structures thereof are adjacent. In a case in which the above-described structure is employed, during charging, electrons (e⁻) are supplied to the negative electrode side, and lithium ions (Li⁺) are accumulated on the negative electrode side. On the other hand, during discharging, the lithium ions (Li⁺) accumulated in the negative electrode return to the positive electrode side, and electrons are supplied to an operation portion 6. In an example illustrated in the drawing, an electric bulb is employed as a model at the operation portion 6 and is lit by discharging.

In a case where the all-solid state secondary battery having a layer configuration illustrated in FIG. 1 is put into a 2032-type coin case, the all-solid state secondary battery will be referred to as the “laminate for an all-solid state secondary battery”, and a battery prepared by putting this laminate for an all-solid state secondary battery into a 2032-type coin case will be referred to as “all-solid state secondary battery”, thereby referring to both batteries distinctively in some cases.

(Positive Electrode Active Material Layer, Solid Electrolyte Layer, and Negative Electrode Active Material Layer)

In the all-solid state secondary battery 10, the positive electrode in which the positive electrode collector and the positive electrode active material layer are laminated, the solid electrolyte layer, and the negative electrode in which the negative electrode collector and the negative electrode active material layer are laminated are all composed of the sheet for an all-solid state secondary battery manufactured by the manufacturing method for a sheet for an all-solid state secondary battery according to the embodiment of the present invention. It is noted that the solid electrolyte sheet for an all-solid state secondary battery, which constitutes the solid electrolyte layer, is used by peeling off the base material therefrom.

The solid electrolyte layer contains an inorganic solid electrolyte having an ion conductivity of a metal belonging to Group 1 or Group 2 in the periodic table, and a component described later within a range where the effect of the present invention is not impaired, and it generally does not contain a positive electrode active material and/or a negative electrode active material. The content of the inorganic solid electrolyte and the like in the solid electrolyte layer is the same as the content in 100% by mass of the solid content of the inorganic solid electrolyte-containing composition described later.

The positive electrode active material layer contains an inorganic solid electrolyte having an ion conductivity of a metal belonging to Group 1 or Group 2 in the periodic table, a positive electrode active material, and a component described later within a range where the effect of the present invention is not impaired. The content of the positive electrode active material, the inorganic solid electrolyte, and the like in the positive electrode active material layer is the same as the content in 100% by mass of the solid content in the positive electrode composition described later.

The negative electrode active material layer contains an inorganic solid electrolyte having an ion conductivity of a metal belonging to Group 1 or Group 2 in the periodic table, a negative electrode active material, and a component described later within a range where the effect of the present invention is not impaired. The content of the negative electrode active material, the inorganic solid electrolyte, and the like in the negative electrode active material layer is the same as the content in 100% by mass of the solid content in the negative electrode composition described later.

In the all-solid state secondary battery 10, the negative electrode active material layer can be a lithium metal layer. Examples of the lithium metal layer include a layer formed by depositing or molding a lithium metal powder, a lithium foil, and a lithium vapor deposition film. The thickness of the lithium metal layer can be, for example, 1 to 500 μm regardless of the above thickness of the above negative electrode active material layer.

The compositions of the positive electrode active material layer 4, the solid electrolyte layer 3, and the negative electrode active material layer 2 may be identical to or different from each other.

In the present invention, any one of the positive electrode active material layer and the negative electrode active material layer, or collectively both of them may be simply referred to as an active material layer or an electrode active material layer. In addition, in the present invention, any one of the positive electrode active material and the negative electrode active material, or collectively both of them may be simply referred to as an active material or an electrode active material.

(Collector)

The positive electrode collector 5 and the negative electrode collector 1 are as described above.

<Use Application of all-Solid State Secondary Battery>

The all-solid state secondary battery according to the embodiment of the present invention can be applied to a variety of usages. The application aspect thereof is not particularly limited, and in a case of being mounted in an electronic apparatus, examples thereof include a notebook computer, a pen-based input personal computer, a mobile personal computer, an e-book player, a mobile phone, a cordless phone handset, a pager, a handy terminal, a portable fax, a mobile copier, a portable printer, a headphone stereo, a video movie, a liquid crystal television, a handy cleaner, a portable CD, a mini disc, an electric shaver, a transceiver, an electronic notebook, a calculator, a memory card, a portable tape recorder, a radio, and a backup power supply. Additionally, examples of consumer usages include automobiles (electric vehicles and the like), electric vehicles, motors, lighting equipment, toys, game devices, road conditioners, watches, strobes, cameras, medical devices (pacemakers, hearing aids, and shoulder massage devices, and the like). Furthermore, the all-solid state secondary battery can be used for a variety of military usages and universe usages. In addition, the all-solid state secondary battery can also be combined with a solar battery.

[Manufacturing Method for Sheet for all-Solid State Secondary Battery]

The manufacturing method for a sheet for an all-solid state secondary battery according to the embodiment of the present invention (sometimes referred to as a sheet manufacturing method according to the embodiment of the present invention) is a manufacturing method in which in a sheet manufacturing method of subjecting (carrying out application and drying) an inorganic solid electrolyte-containing composition containing an inorganic solid electrolyte having an ion conductivity of a metal belonging to Group 1 or Group 2 in the periodic table and a dispersion medium, to application and film formation onto a base material, any one or preferably both of the preparation temperature and the temperature before the application and film formation of the inorganic solid electrolyte-containing composition (also simply referred to as a temperature before film formation) is set to 35° C. to 90° C. to carry out the preparation or the application and film formation.

Since the preparation temperature and the temperature before the film formation are set in the above temperature range, excellent dispersion characteristics and excellent application suitability can be imparted to the inorganic solid electrolyte-containing composition as described above. As a result, in a case where the sheet for an all-solid state secondary battery, which is manufactured by using this inorganic solid electrolyte-containing composition, is incorporated into an all-solid state secondary battery as a constitutional layer, an all-solid state secondary battery that exhibits excellent cycle characteristics as compared those in the related art can be realized as described above.

In the sheet manufacturing method according to the embodiment of the present invention, the above-described effect is exhibited by setting any one or both of the preparation temperature and the temperature before the film formation in the above temperature range. However, It is preferable to set at least the temperature before the film formation in the above temperature range from the viewpoint that the application suitability of the inorganic solid electrolyte-containing composition before the film formation (before the application) in addition to the dispersion characteristics thereof can be further improved, and it is more preferable to set both the preparation temperature and the pre-film formation temperature in the above temperature range from the viewpoint that both the dispersion characteristics and the application suitability can be achieved at a higher level.

In the sheet manufacturing method according to the embodiment of the present invention, a sheet for an all-solid state secondary battery can be manufactured in basically the same manner as in a conventional method of forming a film using the inorganic solid electrolyte-containing composition except that the preparation temperature and the temperature before the film formation of the inorganic solid electrolyte-containing composition are set in the above range and that an inorganic solid electrolyte-containing composition having a high solid content concentration can be used.

First, a preparation method for the inorganic solid electrolyte-containing composition and a film forming method will be described.

<Preparation Method for Inorganic Solid Electrolyte-Containing Composition>

The inorganic solid electrolyte-containing composition is prepared as a mixture and preferably as a slurry by mixing an inorganic solid electrolyte and a dispersion medium, as well as preferably a binder, appropriately a conductive auxiliary agent, a lithium salt, and any other optionally components, by using, for example, various mixers that are used generally. In a case of manufacturing an electrode sheet for an all-solid state secondary battery, an active material is further mixed with the inorganic solid electrolyte-containing composition (the electrode composition).

The mixing method is not particularly limited, and it can be carried out using a known mixer such as a ball mill, a beads mill, a planetary mixer, a blade mixer, a roll mill, a kneader, a disc mill, a self-rotation type mixer, or a narrow gap type disperser.

The mixing conditions are also not particularly limited. For example, the rotation speed of the self-rotation type mixer or the like can be set to 200 to 3,000 rpm. The mixing atmosphere may be any one of in the atmosphere, under dry air (the dew point: −20° C. or lower), in an inert gas (for example, in an argon gas, in a helium gas, or in a nitrogen gas), or the like. Since the inorganic solid electrolyte easily reacts with moisture, the mixing is preferably carried out under dry air or in an inert gas.

The mixing temperature (also referred to as a preparation temperature or a dispersion temperature) and the mixing time are not particularly limited either, and an appropriate temperature can be applied. For example, it can be set to 15° C. or higher. In the present invention, the mixing temperature is preferably set to 35° C. or higher, and it is more preferably set to 40° C. or higher. The upper limit of the mixing temperature is preferably set to 90° C. or lower, more preferably set to 80° C. or lower, still more preferably set to 70° C. or lower, particularly preferably set to 65° C. or lower, and most preferably set to 60° C. or lower. The method of heating the inorganic solid electrolyte-containing composition to the above-described temperature is not particularly limited. For example, it is preferable to heat a component such as a dispersion medium in advance, and it is also suitable to use a heating function of a mixer. In a case of preparing the inorganic solid electrolyte-containing composition at a temperature in the above range, it is possible to obtain an inorganic solid electrolyte-containing composition having particularly excellent dispersion characteristics even in a case where the solid content concentration is high. The mixing time, in this case, is not particularly limited and can be set to, for example, 1 to 60 minutes, and the lower limit thereof can be set to 10 seconds in a case where a self-rotation type mixer or the like is used.

In the present invention, the individual components may be mixed collectively, may be mixed sequentially, or may be mixed in multiple stages. In a case of carrying out mixing in multiple stages, at least in the final mixing stage of mixing all the components to be used in the dispersion medium, the mixing temperature is preferably set in the above range, and the mixing temperature may be set in the above range in each mixing stage. In addition, the mixing conditions at each stage are generally set to the above-described mixing conditions.

<Method of Forming Film of Inorganic Solid Electrolyte-Containing Composition>

In the sheet manufacturing method according to the embodiment of the present invention, the prepared inorganic solid electrolyte-containing composition is subsequently formed into a film on a base material, that is, it is applied (subjected to coating) onto the surface of the base material and dried.

In the present invention, the prepared inorganic solid electrolyte-containing composition (non-heated or at a temperature lower than 35° C.) can be formed into a film as it is; however, it is preferable to heat the composition to a temperature before film formation, before the film formation. As a result, even in a case where the solid content concentration is set to be high, it is possible to realize excellent application suitability that cannot be realized with a simply prepared inorganic solid electrolyte-containing composition while maintaining the dispersion characteristics. In the present invention, heating the inorganic solid electrolyte-containing composition before the film formation includes in addition to an aspect in which an inorganic solid electrolyte-containing composition that has not reached the temperature before the film formation (a composition which has been prepared at a preparation temperature outside the above-described range, a composition in which the temperature is decreased after preparation, and the like) is heated to the temperature before the film formation, an aspect in which the temperature of the inorganic solid electrolyte-containing composition prepared at a preparation temperature of 35° C. to 90° C. is maintained (heat retention is carried out) until being applied.

The temperature before the film formation refers to the temperature of the inorganic solid electrolyte-containing composition at the time of (immediately before) being applied, and it is set within the same range as the above-described preparation temperature; however, it does not need to be set to the same temperature as the preparation temperature. The method of heating the inorganic solid electrolyte-containing composition before the film formation to the above-described temperature is not particularly limited. Examples thereof include a method of heating the inorganic solid electrolyte-containing composition in advance with a mixer, a constant temperature bath, or the like, and a method of heating the inorganic solid electrolyte-containing composition while transferring it in a heated pipe. The method of maintaining the temperature is not particularly limited, and examples thereof include a heat retention method based on the above-described heating method. In a case of heating the inorganic solid electrolyte-containing composition, it is preferable to stir or cause the inorganic solid electrolyte-containing composition to flow. In the heating or heat retention of the inorganic solid electrolyte-containing composition, it is preferable that the temperature is stable. The heating time is not particularly limited as long as it reaches a predetermined temperature, and it may be, for example, 1 to 60 minutes. In addition, heating conditions and heat retention conditions can be appropriately set.

(Application)

In the sheet manufacturing method according to the embodiment of the present invention, the method of applying the inorganic solid electrolyte-containing composition is not particularly limited and can be appropriately selected. Examples thereof include wet-type coating methods such as spray coating, spin coating, dip coating, slit coating, stripe coating, and bar coating.

The inorganic solid electrolyte-containing composition is formed into a film after preparation. However, at this time, the time from preparation to film formation (application) is appropriately determined in consideration of the dispersion characteristics of the inorganic solid electrolyte-containing composition. For example, in a case where the inorganic solid electrolyte-containing composition is not heated or kept warm before the film formation, it is preferable to form a film within 48 hours after the preparation. On the other hand, in a case where the inorganic solid electrolyte-containing composition is heated or kept warm before the film formation, the time may exceed 48 hours, which is not particularly limited. The time from heating or heat retention to film formation (application) is appropriately determined in consideration of the dispersion characteristics, application suitability, and the like of the inorganic solid electrolyte-containing composition. For example, film formation is preferably carried out within 48 hours after heating or heat retention, and it is more preferably carried out within 12 hours.

In the application of the inorganic solid electrolyte-containing composition, the base material is generally used without being heated or cooled; however, it may be heated. The heating temperature of the base material is not particularly limited; however, it is set, for example, within a range of the temperature before the film formation.

(Drying)

The drying temperature of the applied inorganic solid electrolyte-containing composition is not particularly limited as long as the dispersion medium can be removed, and it is appropriately set according to the boiling point of the dispersion medium. For example, the lower limit of the drying temperature is preferably 60° C. or higher, more preferably 90° C. or higher, still more preferably 100° C. or higher, and particularly preferably 120° C. or higher. The upper limit thereof is preferably 300° C. or lower, more preferably 250° C. or lower, still more preferably 230° C. or lower, and particularly preferably 200° C. or lower. The drying method for the inorganic solid electrolyte-containing composition is not particularly limited, and various known drying methods can be applied. The drying time is not particularly limited, and it may be, for example, 1 minute or more and 5 hours or less.

The applied inorganic solid electrolyte-containing composition is generally quickly dried; however, it may be dried at time intervals within a range where the effect (dispersion characteristics or application suitability) of the present invention is not impaired.

In this way, a layer (coated and dried layer) consisting of the inorganic solid electrolyte-containing composition can be formed. Here, the coated and dried layer means a layer formed by applying the inorganic solid electrolyte-containing composition and drying and removing the dispersion medium, and the dispersion medium may remain within a range where the effect of the present invention is not impaired, and the residual amount thereof, for example, in each of the layers can be set to 3% by mass or lower.

(Pressurization)

The coated and dried layer is preferably pressurized. Examples of the pressurizing method include a method using a hydraulic cylinder press machine. The pressurizing force is not particularly limited; however, it is generally preferably in a range of 5 to 1,500 MPa.

In addition, the applied inorganic solid electrolyte-containing composition may be subjected to heating and pressurization at the same time. The heating temperature at this time is the same as the drying temperature described above, and the pressing can be carried out at a temperature higher than the glass transition temperature of the inorganic solid electrolyte. It is also possible to carry out press at a temperature higher than the glass transition temperature of the polymer contained in the binder. However, in general, the temperature does not exceed the melting point of this polymer.

The pressurization may be carried out in a state where the coating solvent or dispersion medium has been dried in advance or in a state where the solvent or the dispersion medium remains.

The pressurization time may be a short time (for example, within several hours) under the application of a high pressure or a long time (one day or longer) under the application of an intermediate pressure. The pressing pressure may be a pressure that is constant or varies with respect to a portion under pressure such as a sheet surface. The pressing pressure may be variable depending on the area or the film thickness of the portion under pressure. In addition, the pressure may also be variable stepwise for the same portion. A pressing surface may be flat or roughened.

The atmosphere in the film forming method (application, drying, pressurization (under heating)) is not particularly limited, and it is possible to appropriately apply, for example, the mixing atmosphere in the preparation method for the inorganic solid electrolyte-containing composition without particular limitation.

As described above, the inorganic solid electrolyte-containing composition is applied onto a base material to be formed into a film, whereby a sheet for an all-solid state secondary battery is manufactured.

<Inorganic Solid Electrolyte-Containing Composition>

Next, the inorganic solid electrolyte-containing composition that is used in the sheet manufacturing method according to the embodiment of the present invention will be described.

The inorganic solid electrolyte-containing composition that is used in the sheet manufacturing method according to the embodiment of the present invention contains an inorganic solid electrolyte having an ion conductivity of a metal belonging to Group 1 or Group 2 in the periodic table and a dispersion medium. This inorganic solid electrolyte-containing composition is preferably a slurry in which the inorganic solid electrolyte is dispersed in a dispersion medium.

The solid content concentration of the inorganic solid electrolyte-containing composition is not particularly limited and can be appropriately set to, for example, 20% to 80% by mass. The solid content concentration is preferably 30% to 70% by mass and more preferably 40 to 60% by mass.

In the present invention, since the dispersion characteristics and the application suitability can be effectively improved by setting the preparation temperature and the temperature before the film formation of the inorganic solid electrolyte-containing composition in the above ranges, it is possible to use a high-concentration composition in which the solid content concentration is set to be higher than that in the related art, as the inorganic solid electrolyte-containing composition. For example, the lower limit value of the solid content concentration of the high-concentration composition can be set to more than 50% by mass, and it is preferably more than 60% by mass, more preferably 65% by mass or more, and still more preferably 70% by mass or more. The upper limit value thereof is less than 100% by mass and can be set to, for example, 90% by mass or less. It is preferably 85% by mass or less and more preferably 80% by mass or less.

The viscosity of the inorganic solid electrolyte-containing composition that is used in the sheet manufacturing method according to the embodiment of the present invention at 25° C. (room temperature) is not particularly limited. From the viewpoints of the improvement of the dispersion characteristics and the application suitability as well as the setting of the viscosity change width Δ described above, the viscosity at 25° C. is preferably 200 to 15,000 cP, more preferably 500 to 10,000 cP, still more preferably 200 to 8,000 cP, and particularly preferably 400 to 6,000 cP.

In addition, in the sheet manufacturing method according to the embodiment of the present invention, it is preferable to use an inorganic solid electrolyte-containing composition in which the difference (in terms of absolute value) between the viscosity of the inorganic solid electrolyte-containing composition at 25° C. and the viscosity of the inorganic solid electrolyte-containing composition at a higher temperature among the preparation temperature and the temperature before the film formation is 1,000 cP or more. In a case where this viscosity difference (the viscosity change width Δ) is 1,000 cP or more, the molecular motion of the solid particle becomes active in the inorganic solid electrolyte-containing composition at the time of preparation or before film formation, and thus the dispersion characteristics as well as the application suitability can be expected to be further improved. The viscosity change width Δ is more preferably 1,200 cP or more and still more preferably 1,500 cP or more. The upper limit value of the viscosity change width Δ is not particularly limited; however, it is practically 10,000 cP or less and preferably 5,000 cP or less.

Although the viscosity at the preparation temperature and the temperature before the film formation is not particularly limited, it is generally lower than the viscosity at 25° C. It is preferably 50 to 3,500 cP, more preferably 100 to 3,000 cP, and still more preferably 200 to 2,500 cP, from the viewpoints of the improvement of the dispersion characteristics and the application suitability as well as the setting of the viscosity change width Δ described above.

The viscosity of the inorganic solid electrolyte-containing composition at each temperature shall be a value calculated according to a method described in Examples.

The viscosity of the inorganic solid electrolyte-containing composition can be appropriately set, for example, by changing or adjusting the solid content concentration of the inorganic solid electrolyte-containing composition, the kind or content of the solid particle or the binder, the kind of the dispersion medium, and the like, and moreover, the dispersion conditions. In particular, the viscosity change width Δ can be set within the above-described range by changing or adjusting the solid content concentration of the inorganic solid electrolyte-containing composition, the kind of the dispersion medium, the preparation temperature, or the temperature before the film formation.

The inorganic solid electrolyte-containing composition is preferably a non-aqueous composition. In the present invention, the non-aqueous composition includes not only an aspect including no moisture but also an aspect where the moisture content (also referred to as the “water content”) is preferably 500 ppm or less. In the non-aqueous composition, the moisture content is more preferably 200 ppm or less, still more preferably 100 ppm or less, and particularly preferably 50 ppm or less. In a case where the inorganic solid electrolyte-containing composition is a non-aqueous composition, it is possible to suppress the deterioration of the inorganic solid electrolyte. The water content refers to the water amount (the mass proportion to the inorganic solid electrolyte-containing composition) in the inorganic solid electrolyte-containing composition, and specifically, it is a value measured by carrying out filtration through a 0.02 μm membrane filter and then Karl Fischer titration.

The inorganic solid electrolyte-containing composition includes an aspect containing not only an inorganic solid electrolyte but also an active material, as well as a conductive auxiliary agent or the like (the composition of this aspect may be referred to as the “electrode composition”).

Hereinafter, components that are contained and components that can be contained in the inorganic solid electrolyte-containing composition will be described.

### <Inorganic Solid Electrolyte>

The inorganic solid electrolyte-containing composition contains an inorganic solid electrolyte (it is also referred to as inorganic solid electrolyte particles in a case of having a particle shape).

In the present invention, the inorganic solid electrolyte is an inorganic solid electrolyte, where the solid electrolyte refers to a solid-form electrolyte capable of migrating ions therein. The inorganic solid electrolyte is clearly distinguished from the organic solid electrolyte (the polymeric electrolyte such as polyethylene oxide (PEO) or the organic electrolyte salt such as lithium bis(trifluoromethanesulfonyl)imide (LiTFSI)) since it does not include any organic substance as a principal ion-conductive material. In addition, the inorganic solid electrolyte is solid in a steady state and thus, typically, is not dissociated or liberated into cations and anions. Due to this fact, the inorganic solid electrolyte is also clearly distinguished from inorganic electrolyte salts of which cations and anions are dissociated or liberated in electrolytic solutions or polymers (LiPF₆, LiBF₄, lithium bis(fluorosulfonyl)imide (LiFSI), LiCl, and the like). The inorganic solid electrolyte is not particularly limited as long as it has an ion conductivity of a metal belonging to Group 1 or Group 2 in the periodic table and generally does not have electron conductivity. In a case where the all-solid state secondary battery according to the embodiment of the present invention is a lithium ion battery, the inorganic solid electrolyte preferably has a lithium ion conductivity.

As the inorganic solid electrolyte, a solid electrolyte material that is typically used for an all-solid state secondary battery can be appropriately selected and used. Examples of the inorganic solid electrolyte include (i) a sulfide-based inorganic solid electrolyte, (ii) an oxide-based inorganic solid electrolyte, (iii) a halide-based inorganic solid electrolyte, and (iv) a hydride-based inorganic solid electrolyte. The sulfide-based inorganic solid electrolytes are preferably used from the viewpoint that it is possible to form a more favorable interface between the active material and the inorganic solid electrolyte.

(i) Sulfide-Based Inorganic Solid Electrolyte

The sulfide-based inorganic solid electrolyte is preferably an electrolyte that contains a sulfur atom, has an ion conductivity of a metal belonging to Group 1 or Group 2 in the periodic table, and has electron-insulating properties. The sulfide-based inorganic solid electrolytes are preferably inorganic solid electrolytes which contain, as elements, at least Li, S, and P and have a lithium ion conductivity, but the sulfide-based inorganic solid electrolytes may also include elements other than Li, S, and P depending on the purposes or cases.

Examples of the sulfide-based inorganic solid electrolyte include a lithium ion-conductive inorganic solid electrolyte satisfying the composition represented by Formula (S1).

Lₐ₁M_{b1}P_{c1}S_{d1}Aₑ₁ (S1)

In the formula, L represents an element selected from Li, Na, or K and is preferably Li. M represents an element selected from B, Zn, Sn, Si, Cu, Ga, Sb, Al, or Ge. A represents an element selected from I, Br, Cl, or F. a1 to e1 represent the compositional ratios between the respective elements, and a1:b1:c1:d1:e1 satisfies 1 to 12:0 to 5:1:2 to 12:0 to 10. a1 is preferably 1 to 9 and more preferably 1.5 to 7.5. b1 is preferably 0 to 3 and more preferably 0 to 1. d1 is preferably 2.5 to 10 and more preferably 3.0 to 8.5. e1 is preferably 0 to 5 and more preferably 0 to 3.

The compositional ratios between the respective elements can be controlled by adjusting the amounts of raw material compounds blended to manufacture the sulfide-based inorganic solid electrolyte as described below.

The sulfide-based inorganic solid electrolytes may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolytes can be manufactured by a reaction of at least two or more raw materials of, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, LiI, LiBr, and LiCl), or sulfides of an element represented by M (for example, SiS₂, SnS, and GeS₂).

The ratio of Li₂S to P₂S₅ in Li—P—S-based glass and Li—P—S-based glass ceramic is preferably 60:40 to 90:10 and more preferably 68:32 to 78:22 in terms of the molar ratio, Li₂S:P₂S₅. In a case where the ratio between Li₂S and P₂S₅ is set in the above-described range, it is possible to increase a lithium ion conductivity. Specifically, the lithium ion conductivity can be preferably set to 1×10'S/cm or more and more preferably set to 1×10⁻³ S/cm or more. The upper limit thereof is not particularly limited, however, it is practically 1×10⁻¹ S/cm or less.

As specific examples of the sulfide-based inorganic solid electrolytes, combination examples of raw materials will be described below. Examples thereof include Li₂S—P₂S₅, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—Ge_{S}2-Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—P₂S₅—LiI, Li₂S—SiS₂—LiI, Li₂S—SiS₂—Li₄SiO₄, Li₂S—SiS₂—Li₃PO₄, and Li₁₀GeP₂S₁₂. The mixing ratio between the individual raw materials does not matter. Examples of the method of synthesizing a sulfide-based inorganic solid electrolyte material using the above-described raw material compositions include an amorphization method. Examples of the amorphization method include a mechanical milling method, a solution method, and a melting quenching method. This is because treatments at a normal temperature become possible, and it is possible to simplify manufacturing processes.

(ii) Oxide-Based Inorganic Solid Electrolytes

The oxide-based inorganic solid electrolyte is preferably an electrolyte that contains an oxygen atom, has an ion conductivity of a metal belonging to Group 1 or Group 2 in the periodic table, and has electron-insulating properties.

The ion conductivity of the oxide-based inorganic solid electrolyte is preferably 1×10⁻⁶ S/cm or more, more preferably 5×10⁻⁶ S/cm or more, and particularly preferably 1×10⁻⁵ S/cm or more. The upper limit thereof is not particularly limited; however, it is practically 1×10⁻¹ S/cm or less.

Specific examples of the compound include LiₓₐLa_{ya}TiO₃ (LLT) [xa satisfies 0.3≤xa≤0.7, and ya satisfies 0.3≤ya≤0.7]; Li_{xb}La_{yb}Zr_{zb}M^{bb}_{mb}O_{nb} (M^{bb} is one or more elements selected from Al, Mg, Ca, Sr, V, Nb, Ta, Ti, Ge, In, and Sn, xb satisfies 5≤xb≤10, yb satisfies 1≤yb≤4, zb satisfies 1≤zb≤4, mb satisfies 0≤mb≤2, and nb satisfies 5≤nb≤20); Li_{xc}B_{yc}M^{cc}_{zc}O_{nc} (M^{cc} is one or more elements selected from C, S, Al, Si, Ga, Ge, In, and Sn, xc satisfies 0<xc≤5, yc satisfies 0<yc≤1, zc satisfies 0<zc≤1, and nc satisfies 0<nc≤6); Li_{xd}(Al, Ga)_{yd}(Ti, Ge)_{zd}Si_{ad}P_{md}O_{nd} (xd satisfies 1≤xd≤3, yd satisfies 0≤yd≤1, zd satisfies 0≤zd≤2, ad satisfies 0≤ad≤1, md satisfies 1≤md≤7, and nd satisfies 3≤nd≤13.); Li₍₃₋₂ₓₑ₎M^{ee}ₓₑD^{ee}O (xe represents a number between 0 and 0.1, and M^{ee} represents a divalent metal atom, D^{ee} represents a halogen atom or a combination of two or more halogen atoms); Li_{xf}Si_{yf}O_{zf} (xf satisfies 1≤xf≤5, yf satisfies 0<yf≤3, zf satisfies 1≤zf≤10); Li_{xg}S_{yg}O_{zg} (xg satisfies 1≤xg≤3, yg satisfies 0<yg≤2, zg satisfies 1≤zg≤10); Li₃BO₃; Li₃BO₃—Li₂SO₄; Li₂O—B₂O₃—P₂O₅; Li₂O—SiO₂; Li₆BaLa₂Ta₂O₁₂; Li₃PO_{(4-3/2w)}N_{w} (w satisfies w<1); Li_{3.5}Zn_{0.25}GeO₄ having a lithium super ionic conductor (LISICON)-type crystal structure; La_{0.55}Li_{0.35}TiO₃ having a perovskite-type crystal structure; LiTi₂P₃O₁₂ having a natrium super ionic conductor (NASICON)-type crystal structure; Li_{1+xh+yh}(Al, Ga)ₓₕ(Ti, Ge)₂₋ₓₕSi_{yh}P_{3-yh}O₁₂ (xh satisfies 0≤xh≤1, and yh satisfies 0≤yh≤1); and Li₇La₃Zr₂O₁₂ (LLZ) having a garnet-type crystal structure.

In addition, a phosphorus compound containing Li, P, or O is also desirable. Examples thereof include lithium phosphate (Li₃PO₄); LiPON in which a part of oxygen atoms in lithium phosphate are substituted with a nitrogen atom; and LiPOD¹ (D¹ is preferably one or more elements selected from Ti, V, Cr, Mn, Fe, Co, Ni, Cu, Zr, Nb, Mo, Ru, Ag, Ta, W, Pt, and Au).

Further, it is also possible to preferably use LiA¹ON (A¹ is one or more elements selected from Si, B, Ge, Al, C, and Ga).

(iii) Halide-Based Inorganic Solid Electrolyte

The halide-based inorganic solid electrolyte is preferably a compound that contains a halogen atom, has an ion conductivity of a metal belonging to Group 1 or Group 2 in the periodic table, and has electron-insulating properties.

The halide-based inorganic solid electrolyte is not particularly limited; however, examples thereof include LiCl, LiBr, LiI, and compounds such as Li₃YBr₆ or Li₃YCl₆ described in ADVANCED MATERIALS, 2018, 30, 1803075. In particular, Li₃YBr₆ or Li₃YCl₆ is preferable.

(iv) Hydride-Based Inorganic Solid Electrolyte

The hydride-based inorganic solid electrolyte is preferably a compound that contains a hydrogen atom, has an ion conductivity of a metal belonging to Group 1 or Group 2 in the periodic table, and has electron-insulating properties.

The hydride-based inorganic solid electrolyte is not particularly limited; however, examples thereof include LiBH₄, Li₄(BH₄)₃I, and 3LiBH₄—LiCl.

The inorganic solid electrolyte is preferably particulate. In this case, the average particle diameter (the volume average particle diameter) of the inorganic solid electrolyte is not particularly limited; however, it is preferably 0.01 μm or more and more preferably 0.1 μm or more. The upper limit is preferably 100 μm or less and more preferably 50 μm or less.

The average particle diameter of the inorganic solid electrolyte is measured in the following procedure. Using water (heptane in a case where the inorganic solid electrolyte is unstable in water), the inorganic solid electrolyte particles are diluted in a 20 mL sample bottle to prepare 1% by mass of a dispersion liquid. The diluted dispersion liquid sample is irradiated with 1 kHz ultrasonic waves for 10 minutes and is then immediately used for testing. Data collection is carried out 50 times using this dispersion liquid sample, a laser diffraction/scattering-type particle size distribution analyzer LA-920 (product name, manufactured by Horiba Ltd.), and a quartz cell for measurement at a temperature of 25° C. to obtain the volume average particle diameter. Other detailed conditions and the like can be found in Japanese Industrial Standards (JIS) Z8828: 2013 “particle diameter Analysis-Dynamic Light Scattering” as necessary. Five samples per level are produced, and the average values therefrom are employed.

The inorganic solid electrolyte-containing composition may contain one kind or two or more kinds of inorganic solid electrolytes.

The content of the inorganic solid electrolyte in the inorganic solid electrolyte-containing composition is not particularly limited. However, from the viewpoints of the reduction of dispersion characteristics and the binding property, it is preferably 50% by mass or more, more preferably 70% by mass or more, and still more preferably 90% by mass or more, with respect to 100% by mass of the solid content. From the same viewpoint, the upper limit thereof is preferably 99.9% by mass or less, more preferably 99.5% by mass or less, and particularly preferably 99% by mass or less.

However, in a case where the inorganic solid electrolyte-containing composition contains an active material described later, regarding the content of the inorganic solid electrolyte in the inorganic solid electrolyte-containing composition, the total content of the active material and the inorganic solid electrolyte is preferably in the above-described range.

In the present invention, the solid content (solid component) refers to components that neither volatilize nor evaporate and disappear in a case where the inorganic solid electrolyte-containing composition is subjected to drying treatment at 150° C. for 6 hours in a nitrogen atmosphere at a pressure of 1 mmHg. Typically, the solid content refers to a constitutional component other than a dispersion medium described later.

<Dispersion Medium>

It suffices that the dispersion medium contained in the inorganic solid electrolyte-containing composition is an organic compound that is in a liquid state in the use environment, examples thereof include various organic solvents, and specific examples thereof include an alcohol compound, an ether compound, an amide compound, an amine compound, a ketone compound, an aromatic compound, an aliphatic compound, a nitrile compound, and an ester compound.

The dispersion medium may be a non-polar dispersion medium (a hydrophobic dispersion medium) or a polar dispersion medium (a hydrophilic dispersion medium); however, a non-polar dispersion medium is preferable from the viewpoint that excellent dispersibility can be exhibited. The non-polar dispersion medium generally refers to a dispersion medium having a property of a low affinity to water; however, in the present invention, examples thereof include an ester compound, a ketone compound, an ether compound, an aromatic compound, and an aliphatic compound.

Examples of the alcohol compound include methyl alcohol, ethyl alcohol, 1-propyl alcohol, 2-propyl alcohol, 2-butanol, ethylene glycol, propylene glycol, glycerin, 1,6-hexanediol, cyclohexanediol, sorbitol, xylitol, 2-methyl-2,4-pentanediol, 1,3-butanediol, and 1,4-butanediol.

Examples of the ether compound include an alkylene glycol (diethylene glycol, triethylene glycol, polyethylene glycol, dipropylene glycol, or the like), an alkylene glycol monoalkyl ether (ethylene glycol monomethyl ether, ethylene glycol monobutyl ether, propylene glycol monomethyl ether, diethylene glycol monomethyl ether, dipropylene glycol monomethyl ether, tripropylene glycol monomethyl ether, diethylene glycol monobutyl ether or the like), alkylene glycol dialkyl ether (ethylene glycol dimethyl ether or the like), a dialkyl ether (dimethyl ether, diethyl ether, diisopropyl ether, dibutyl ether, or the like), and a cyclic ether (tetrahydrofuran, dioxane (including 1,2-, 1,3- or 1,4-isomer), or the like).

Examples of the amide compound include N,N-dimethylformamide, N-methyl-2-pyrrolidone, 2-pyrrolidinone, 1,3-dimethyl-2-imidazolidinone, ε-caprolactam, formamide, N-methylformamide, acetamide, N-methylacetamide, N,N-dimethylacetamide, N-methylpropanamide, and hexamethylphosphoric triamide.

Examples of the amine compound include triethylamine, diisopropylethylamine, and tributylamine.

Examples of the ketone compound include acetone, methyl ethyl ketone, methyl isobutyl ketone (MIBK), cyclopentanone, cyclohexanone, cycloheptanone, dipropyl ketone, dibutyl ketone, diisopropyl ketone, diisobutyl ketone (DIBK), isobutyl propyl ketone, sec-butyl propyl ketone, pentyl propyl ketone, and butyl propyl ketone.

Examples of the aromatic compound include benzene, toluene, and xylene.

Examples of the aliphatic compound include hexane, heptane, octane, nonane, decane, dodecane, cyclohexane, methylcyclohexane, ethylcyclohexane, cycloheptane, cyclooctane, decalin, paraffin, gasoline, naphtha, kerosine, kerosene, and light oil.

Examples of the nitrile compound include acetonitrile, propionitrile, and isobutyronitrile.

Examples of the ester compound include ethyl acetate, propyl acetate, propyl butyrate, butyl acetate, ethyl butyrate, isopropyl butyrate, butyl butyrate, isobutyl butyrate, butyl pentanoate, pentyl pentanoate, ethyl isobutyrate, propyl isobutyrate, isopropyl isobutyrate, isobutyl isobutyrate, propyl pivalate, isopropyl pivalate, butyl pivalate, and isobutyl pivalate.

In the present invention, among them, an ether compound, a ketone compound, an aromatic compound, an aliphatic compound, or an ester compound is preferable, and an ester compound, a ketone compound, or an ether compound is more preferable.

The number of carbon atoms of the compound that constitutes the dispersion medium is not particularly limited, and it is preferably 2 to 30, more preferably 4 to 20, still more preferably 6 to 15, and particularly preferably 7 to 12.

The boiling point of the dispersion medium at normal pressure (1 atmospheric pressure) is not particularly limited; however, it is preferably 90° C. or higher, more preferably 100° C. or higher, and still more preferably 120° C. or higher, in consideration of the preparation temperature or temperature before the film formation described above, the heating temperature during the film formation, and the like. The upper limit is preferably 250° C. or lower, more preferably 230° C. or lower, still more preferably 200° C. or lower, and most preferably 180° C. or lower.

The inorganic solid electrolyte-containing composition may contain one kind or two or more kinds of dispersion medium.

In the present invention, the content of the dispersion medium in the inorganic solid electrolyte-containing composition is not particularly limited, and it is set in a range that satisfies the above-described solid content concentration.

<Binder>

The inorganic solid electrolyte-containing composition that is used in the sheet manufacturing method according to the embodiment of the present invention preferably contains a binder from the viewpoints of further enhancing the binding property of the solid particles, reinforcing the dispersion characteristics, and the like.

Suitable examples of the binder contained in the inorganic solid electrolyte-containing composition include a binder formed to include one or more kinds of polymers, and as the polymer, a known polymer that is used for manufacturing an all-solid state secondary battery can be used without particular limitation. Examples of such a polymer include sequential polymerization (polycondensation, polyaddition, or addition condensation) polymers such as polyurethane, polyurea, polyamide, polyimide, polyester, a polycarbonate resin, and a polyester resin; chain polymerization polymers such as a fluorine-containing polymer, a hydrocarbon-based polymer, a vinyl polymer, and (meth)acrylic polymer, and copolymerization polymers thereof. In addition, a cellulose polymer is also included. The mass average molecular weight of each of these polymers (a value in terms of standard polystyrene conversion according to gel permeation chromatography (GPC) based on the measuring method described in WO2019/065066A1) is not particularly limited; however, it can be set to 50,000 to 1,500,000. In the present invention, the polymer means a polymer; however, it is synonymous with a so-called polymeric compound. The polymer that forms the binder preferably has a polymer that does not react with solid electrolyte particles during heating, and it may have, for example, an unsaturated bond such as a carbon-carbon double bond in the molecule within a range where the effect of the present invention is not impaired, where it preferably does have an unsaturated bond. The bonding mode of the polymer is not particularly limited, and the chain polymerization polymer may be any one of a block copolymer, an alternating copolymer, or a random copolymer.

The binder contained in the inorganic solid electrolyte-containing composition may be soluble in a dispersion medium (may be a soluble type binder) or may be insoluble in a dispersion medium (may be a particle-shaped binder). The shape of the particle-shaped binder is not particularly limited and may be a flat shape, an amorphous shape, or the like; however, a spherical shape or a granular shape is preferable. The average particle diameter of the particle-shaped binder is preferably 1 to 1,000 nm, more preferably 10 to 800 nm, still more preferably 20 to 500 nm, and particularly preferably 40 to 300 nm. The particle diameter can be measured using the same method as that of the average particle diameter of the inorganic solid electrolyte.

The inorganic solid electrolyte-containing composition may contain one kind or two or more kinds of binders.

The content of the binder in the inorganic solid electrolyte-containing composition is not particularly limited. However, from the viewpoints of dispersion characteristics and application suitability, it is preferably 0.1% to 10.0% by mass, more preferably 0.2% to 5.0% by mass, and still more preferably 0.3% to 4.0% by mass, with respect to 100% by mass of the solid content.

In the present invention, the mass ratio [(the mass of the inorganic solid electrolyte+the mass of the active material)/(the total mass of the binder)] of the total mass (the total amount) of the inorganic solid electrolyte and the active material to the total mass of the binder in the solid content of 100% by mass is preferably in a range of 1,000 to 1. Furthermore, this ratio is more preferably 500 to 2 and still more preferably 100 to 10.

<Active Material>

The inorganic solid electrolyte-containing composition can also contain an active material capable of intercalating and deintercalating an ion of a metal belonging to Group 1 or Group 2 of the periodic table. Examples of such active materials include a positive electrode active material and a negative electrode active material, which will be described later.

In the present invention, the inorganic solid electrolyte-containing composition containing an active material (a positive electrode active material or a negative electrode active material) may be referred to as an electrode composition (a positive electrode composition or a negative electrode composition).

(Positive Electrode Active Material)

The positive electrode active material is an active material capable of intercalating and deintercalating an ion of a metal belonging to Group 1 or Group 2 of the periodic table, and it is preferably one capable of reversibly intercalating and deintercalating a lithium ion. The above-described material is not particularly limited as long as the material has the above-described characteristics and may be a transition metal oxide or an element, which is capable of being complexed with Li, such as sulfur or the like by disassembling the battery.

Among the above, as the positive electrode active material, transition metal oxides are preferably used, and transition metal oxides having a transition metal element Ma (one or more elements selected from Co, Ni, Fe, Mn, Cu, or V) are more preferable. In addition, an element Mb (an element of Group 1 (Ia) of the metal periodic table other than lithium, an element of Group 2 (IIa), or an element such as Al, Ga, In, Ge, Sn, Pb, Sb, Bi, Si, P, or B) may be mixed into this transition metal oxide. The mixing amount thereof is preferably 0% to 30% by mole of the amount (100% by mole) of the transition metal element Ma. It is more preferable that the transition metal oxide is synthesized by mixing the above components such that a molar ratio Li/Ma is 0.3 to 2.2.

Specific examples of the transition metal oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), and lithium-containing transition metal silicate compounds (ME).

Specific examples of the transition metal oxides having a bedded salt-type structure (MA) include LiCoO₂ (lithium cobalt oxide [LCO]), LiNi₂O₂ (lithium nickelate), LiNi_{0.85}Co_{0.10}Al_{0.05}O₂ (lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂ (lithium manganese nickelate).

Specific examples of the transition metal oxides having a spinel-type structure (MB) include LiMn₂O₄ (LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compound (MC) include olivine-type iron phosphate salts such as LiFePO₄ and Li₃Fe₂(PO₄)₃, iron pyrophosphates such as LiFeP₂O₇, and cobalt phosphates such as LiCoPO₄, and a monoclinic NASICON type vanadium phosphate salt such as Li₃V₂(PO₄)₃ (lithium vanadium phosphate).

Examples of the lithium-containing transition metal halogenated phosphoric acid compound (MD) include iron fluorophosphates such as Li₂FePO₄F, manganese fluorophosphates such as Li₂MnPO₄F, cobalt fluorophosphates such as Li₂CoPO₄F.

Examples of the lithium-containing transition metal silicate compounds (ME) include Li₂FeSiO₄, Li₂MnSiO₄, and Li₂CoSiO₄.

In the present invention, the transition metal oxide having a bedded salt-type structure (MA) is preferable, and LCO or NMC is more preferable.

The shape of the positive electrode active material is not particularly limited but is preferably a particle shape. The average particle diameter (the volume average particle diameter) of the positive electrode active material particles is not particularly limited. For example, it can be set to 0.1 to 50 μm. The average particle diameter of the positive electrode active material particles can be measured in the same manner as the average particle diameter of the inorganic solid electrolyte. In order to allow the positive electrode active material to have a predetermined particle diameter, a general pulverizer or classifier is used. For example, a mortar, a ball mill, a sand mill, a vibration ball mill, a satellite ball mill, a planetary ball mill, a swirling air flow jet mill, or a sieve is preferably used. During pulverization, it is also possible to carry out wet-type pulverization in which water or a dispersion medium such as methanol is made to be present together. In order to provide the desired particle diameter, classification is preferably carried out. The classification is not particularly limited and can be carried out using a sieve, a wind power classifier, or the like. Both the dry-type classification and the wet-type classification can be carried out.

A positive electrode active material obtained using a baking method may be used after being washed with water, an acidic aqueous solution, an alkaline aqueous solution, or an organic solvent.

The positive electrode active material contained in the inorganic solid electrolyte-containing composition may be one kind or two or more kinds.

The content of the positive electrode active material in the inorganic solid electrolyte-containing composition is not particularly limited; however, it is preferably 10% to 97% by mass, more preferably 30% to 95% by mass, still more preferably 40% to 93% by mass, and particularly preferably 50% to 90% by mass, in 100% by mass of the solid content.

(Negative Electrode Active Material)

The negative electrode active material is an active material capable of intercalating and deintercalating an ion of a metal belonging to Group 1 or Group 2 of the periodic table, and it is preferably one capable of reversibly intercalating and deintercalating a lithium ion. The material is not particularly limited as long as it has the above-described characteristics, and examples thereof include a carbonaceous material, a metal oxide, a metal composite oxide, a lithium single body, a lithium alloy, and a negative electrode active material that is capable of forming an alloy with lithium. Among the above, a carbonaceous material, a metal composite oxide, or a lithium single body is preferably used from the viewpoint of reliability.

The carbonaceous material that is used as the negative electrode active material is a material substantially consisting of carbon. Examples thereof include petroleum pitch, carbon black such as acetylene black (AB), graphite (natural graphite, artificial graphite such as vapor-grown graphite), and carbonaceous material obtained by baking a variety of synthetic resins such as polyacrylonitrile (PAN)-based resins or furfuryl alcohol resins. Furthermore, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, vitreous carbon fibers, and activated carbon fibers, mesophase microspheres, graphite whisker, and tabular graphite.

These carbonaceous materials can be classified into non-graphitizable carbonaceous materials (also referred to as “hard carbon”) and graphitizable carbonaceous materials based on the graphitization degree. In addition, it is preferable that the carbonaceous material has the lattice spacing, density, and crystallite size described in JP1987-22066A (JP-S62-22066A), JP1990-6856A (JP-H2-6856A), and JP1991-45473A (JP-H3-45473A). The carbonaceous material is not necessarily a single material and, for example, may be a mixture of natural graphite and artificial graphite described in JP1993-90844A (JP-H5-90844A) or graphite having a coating layer described in JP1994-4516A (JP-H6-4516A).

As the carbonaceous material, hard carbon or graphite is preferably used, and graphite is more preferably used.

The oxide of a metal or a metalloid element that can be used as the negative electrode active material is not particularly limited as long as it is an oxide capable of intercalating and deintercalating lithium, and examples thereof include an oxide of a metal element (metal oxide), a composite oxide of a metal element or a composite oxide of a metal element and a metalloid element (collectively referred to as “metal composite oxide), and an oxide of a metalloid element (a metalloid oxide). The oxides are more preferably noncrystalline oxides, and preferred examples thereof include chalcogenides which are reaction products between metal elements and elements in Group 16 of the periodic table). In the present invention, the metalloid element refers to an element having intermediate properties between those of a metal element and a non-metal element. Typically, the metalloid elements include six elements including boron, silicon, germanium, arsenic, antimony, and tellurium, and further include three elements including selenium, polonium, and astatine. In addition, “noncrystalline” represents an oxide having a broad scattering band with an apex in a range of 20° to 40° in terms of 20 value in case of being measured by an X-ray diffraction method using CuKα rays, and the oxide may have a crystalline diffraction line. The highest intensity in a crystalline diffraction line observed in a range of 40° to 70° in terms of 20 value is preferably 100 times or less and more preferably 5 times or less with respect to the intensity of a diffraction line at the apex in a broad scattering band observed in a range of 20° to 40° in terms of 20 value, and it is still more preferable that the oxide does not have a crystalline diffraction line.

In the compound group consisting of the noncrystalline oxides and the chalcogenides, noncrystalline oxides of metalloid elements and chalcogenides are more preferable, and (composite) oxides consisting of one element or a combination of two or more elements selected from elements (for example, Al, Ga, Si, Sn, Ge, Pb, Sb, and Bi) belonging to Groups 13 (IIIB) to 15 (VB) in the periodic table or chalcogenides are more preferable. Specific examples of the preferred noncrystalline oxide and chalcogenide preferably include Ga₂O₃, GeO, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Sb₂O₅, Bi₂O₃, Bi₂O₄, GeS, PbS, PbS₂, Sb₂S₃, and Sb₂S₅.

Preferred examples of the negative electrode active material which can be used in combination with a noncrystalline oxide containing Sn, Si, or Ge as a major component include a carbonaceous material capable of intercalating and/or deintercalating lithium ions or lithium metal, a lithium single body, a lithium alloy, and a negative electrode active material that is capable of being alloyed with lithium.

It is preferable that an oxide of a metal or a metalloid element, in particular, a metal (composite) oxide and the chalcogenide contain at least one of titanium or lithium as the constitutional component from the viewpoint of high current density charging and discharging characteristics. Examples of the metal composite oxide (lithium composite metal oxide) including lithium include a composite oxide of lithium oxide and the above metal (composite) oxide or the above chalcogenide, and specifically, Li₂SnO₂.

As the negative electrode active material, for example, a metal oxide (titanium oxide) having a titanium element is also preferable. Specifically, Li₄Ti₅O₁₂ (lithium titanium oxide [LTO]) is preferable since the volume variation during the intercalation and deintercalation of lithium ions is small, and thus the high-speed charging and discharging characteristics are excellent, and the deterioration of electrodes is suppressed, whereby it becomes possible to improve the life of the lithium ion secondary battery.

The lithium alloy as the negative electrode active material is not particularly limited as long as it is typically used as a negative electrode active material for a secondary battery, and examples thereof include a lithium aluminum alloy, using lithium as a base metal, to which 10% by mass of aluminum is added.

The negative electrode active material capable of forming an alloy with lithium is not particularly limited as long as it is typically used as a negative electrode active material for a secondary battery. Such an active material has a large expansion and contraction due to charging and discharging of the all-solid state secondary battery and accelerates the deterioration of cycle characteristics. However, since the sheet for an all-solid state secondary battery according to the embodiment of the present invention manufactured by the sheet manufacturing method according to the embodiment of the present invention is incorporated as a constitutional layer, the deterioration of the cycle characteristics can be suppressed. Examples of such an active material include a (negative electrode) active material (an alloy or the like) having a silicon element or a tin element and a metal such as Al or In, a negative electrode active material (a silicon element-containing active material) having a silicon element capable of exhibiting high battery capacity is preferable, and a silicon-containing active material in which the content of the silicon element is 50% by mole or more with respect to all the constitutional elements is more preferable.

In general, a negative electrode including the negative electrode active material (for example, an Si negative electrode including a silicon-containing active material or an Sn negative electrode containing an active material containing a tin element) can intercalate a larger amount of Li ions than a carbon negative electrode (for example, graphite or acetylene black). That is, the amount of Li ions intercalated per unit mass increases. As a result, the battery capacity (the energy density) can be increased. As a result, there is an advantage that the battery driving duration can be extended.

Examples of the silicon-containing active material include a silicon-containing alloy (for example, LaSi₂, VSi₂, La—Si, Gd—Si, or Ni—Si) including a silicon material such as Si or SiOx (0<x≤1) and titanium, vanadium, chromium, manganese, nickel, copper, lanthanum, or the like or a structured active material thereof (for example, LaSi₂/Si), and an active material such as SnSiO₃ or SnSiS₃ including silicon element and tin element. In addition, since SiOx itself can be used as a negative electrode active material (a metalloid oxide) and Si is produced along with the operation of an all-solid state secondary battery, SiOx can be used as a negative electrode active material (or a precursor material thereof) capable of being alloyed with lithium.

Examples of the negative electrode active material including tin element include Sn, SnO, SnO₂, SnS, SnS₂, and the above-described active material including silicon element and tin element. In addition, a composite oxide with lithium oxide, for example, Li₂SnO₂ can also be used.

In the present invention, the above-described negative electrode active material can be used without any particular limitation. From the viewpoint of battery capacity, a preferred aspect as the negative electrode active material is a negative electrode active material that is capable of being alloyed with lithium. Among them, the silicon material or the silicon-containing alloy (the alloy containing a silicon element) described above is more preferable, and it is more preferable to include a negative electrode active material containing silicon (Si) or a silicon-containing alloy.

The chemical formulae of the compounds obtained by the above baking method can be calculated using an inductively coupled plasma (ICP) emission spectroscopy as a measuring method from the mass difference of powder before and after baking as a convenient method.

The shape of the negative electrode active material is not particularly limited but is preferably a particle shape. The average particle diameter (the volume average particle diameter) of the negative electrode active material is not particularly limited; however, it is preferably 0.1 to 60 μm. The volume average particle diameter of the negative electrode active material particles can be measured in the same manner as the average particle diameter of the inorganic solid electrolyte. In order to obtain the predetermined particle diameter, a typical pulverizer or classifier is used as in the case of the positive electrode active material.

The inorganic solid electrolyte-containing composition may contain one kind or two or more kinds of negative electrode active material.

The content of the negative electrode active material in the inorganic solid electrolyte-containing composition is not particularly limited, and it is preferably 10% to 90% by mass, more preferably 20% to 85% by mass, still more preferably 30% to 80% by mass, and even still more preferably 40% to 75% by mass, in 100% by mass of the solid content.

(Coating of Active Material)

The surfaces of the positive electrode active material and the negative electrode active material may be subjected to surface coating with another metal oxide. Examples of the surface coating agent include metal oxides and the like containing Ti, Nb, Ta, W, Zr, Al, Si, or Li. Specific examples thereof include titanium oxide spinel, tantalum-based oxides, niobium-based oxides, and lithium niobate-based compounds, and specific examples thereof include Li₄Ti₅O₁₂, Li₂Ti₂O₅, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, and B₂O₃.

In addition, the surface of the electrode containing the positive electrode active material or negative electrode active material may be subjected to a surface treatment with sulfur or phosphorus.

Further, the particle surface of the positive electrode active material or negative electrode active material may be subjected to a surface treatment with an actinic ray or an active gas (plasma or the like) before and after the surface coating.

<Conductive Auxiliary Agent>

It is preferable that the inorganic solid electrolyte-containing composition that is used in the sheet manufacturing method according to the embodiment of the present invention contains a conductive auxiliary agent.

The conductive auxiliary agent is not particularly limited, and conductive auxiliary agents that are known as ordinary conductive auxiliary agents can be used. It may be, for example, graphite such as natural graphite and artificial graphite, carbon black such as acetylene black, Ketjen black, and furnace black, amorphous carbon such as needle cokes, carbon fibers such as a vapor-grown carbon fiber and a carbon nanotube, or a carbonaceous material such as graphene or fullerene, which are electron-conductive materials, and it may be also a metal powder or metal fiber of copper, nickel, or the like. A conductive polymer such as polyaniline, polypyrrole, polythiophene, polyacetylene, or a polyphenylene derivative may also be used.

In the present invention, in a case where the active material is used in combination with the conductive auxiliary agent, among the above-described conductive auxiliary agents, a conductive auxiliary agent that does not intercalate and deintercalate ions (preferably Li ions) of a metal belonging to Group 1 or Group 2 in the periodic table and does not function as an active material at the time of charging and discharging of the battery is classified as the conductive auxiliary agent. Therefore, among the conductive auxiliary agents, a conductive auxiliary agent that can function as the active material in the active material layer at the time of charging and discharging of the battery is classified as an active material but not as a conductive auxiliary agent. Whether or not the conductive auxiliary agent functions as the active material at the time of charging and discharging of a battery is not unambiguously determined but is determined by the combination with the active material.

The shape of the conductive auxiliary agent is not particularly limited but is preferably a particle shape.

The inorganic solid electrolyte-containing composition may contain one kind or two or more kinds of conductive auxiliary agents.

In a case where the inorganic solid electrolyte-containing composition contains a conductive auxiliary agent, the content of the conductive auxiliary agent in the inorganic solid electrolyte-containing composition is preferably 0% to 10% by mass in the solid content of 100% by mass.

<Lithium Salt>

The inorganic solid electrolyte-containing composition that is used in the sheet manufacturing method according to the embodiment of the present invention preferably contains a lithium salt (a supporting electrolyte) as well.

Generally, the lithium salt is preferably a lithium salt that is used for this kind of product and is not particularly limited. For example, lithium salts described in paragraphs 0082 to 0085 of JP2015-088486A are preferable.

In a case where the inorganic solid electrolyte-containing composition contains a lithium salt, the content of the lithium salt is preferably 0.1 part by mass or more and more preferably 5 parts by mass or more with respect to 100 parts by mass of the solid electrolyte. The upper limit thereof is preferably 50 parts by mass or less and more preferably 20 parts by mass or less.

<Dispersing Agent>

The inorganic solid electrolyte-containing composition that is used in the sheet manufacturing method according to the embodiment of the present invention may contain a dispersing agent. A dispersing agent that is generally used for an all-solid state secondary battery can be appropriately selected and used as the dispersing agent. Generally, a compound intended for particle adsorption and steric repulsion and/or electrostatic repulsion is suitably used.

<Other Additives>

As components other than the respective components described above, the inorganic solid electrolyte-containing composition that is used in the sheet manufacturing method according to the embodiment of the present invention may appropriately contain an ionic liquid, a thickener, a crosslinking agent (an agent causing a crosslinking reaction by radical polymerization, condensation polymerization, or ring-opening polymerization), a polymerization initiator (an agent that generates an acid or a radical by heat or light), an antifoaming agent, a leveling agent, a dehydrating agent, or an antioxidant. The ionic liquid is contained in order to further improve the ion conductivity, and the known one in the related art can be used without particular limitation. In addition, a polymer other than the polymer that forms the above-described binder, a typically used binder, or the like may be contained.

[Manufacturing Method for all-Solid State Secondary Battery]

The manufacturing method for an all-solid state secondary battery according to the embodiment of the present invention (also referred to as a battery manufacturing method according to the embodiment of the present invention) is a manufacturing method including a step of manufacturing at least one of the constitutional layers according to the sheet manufacturing method according to the embodiment of the present invention. Specifically, in a general manufacturing method for an all-solid state secondary battery, at least one of the solid electrolyte layer or the active material layer is manufactured according to the sheet manufacturing method according to the embodiment of the present invention. In other words, in a general manufacturing method for an all-solid state secondary battery, the sheet for an all-solid state secondary battery according to the embodiment of the present invention, which is manufactured according to the sheet manufacturing method according to the embodiment of the present invention is used as at least one of the solid electrolyte layer or the active material layer.

The manufacturing method for an all-solid state secondary battery including a collector on a side of the active material opposite to the solid electrolyte layer of the active material includes a step of manufacturing at least one of a positive electrode in which a positive electrode collector and a positive electrode active material layer are laminated, a solid electrolyte layer, or a negative electrode in which a negative electrode collector and a negative electrode active material layer are laminated, according to the sheet manufacturing method according to the embodiment of the present invention. In other words, the electrode sheet for an all-solid state secondary battery according to the embodiment of the present invention manufactured according to the sheet manufacturing method according to the embodiment of the present invention or a solid electrolyte sheet for an all-solid state secondary battery is used as at least one of the electrode which is a laminate of the collector and the active material layer, or the solid electrolyte layer.

It is possible to manufacture an all-solid state secondary battery having excellent cycle characteristics by manufacturing at least one of the constitutional layers according to the sheet manufacturing method according to the embodiment of the present invention, and particularly by manufacturing the electrode according to the sheet manufacturing method according to the embodiment of the present invention.

As each sheet that is used in each of the following manufacturing methods, it is possible to appropriately use the sheet manufactured according to the sheet manufacturing method according to the embodiment of the present invention or a sheet manufactured according to a conventional method. In addition, in a case of forming a film of another layer (carrying out application and drying) directly on the surface of the layer, it is possible to appropriately use an inorganic solid electrolyte-containing composition prepared by setting the preparation temperature in the above-described range, an inorganic solid electrolyte-containing composition heated to the temperature before the application and film formation in the above range, or an inorganic solid electrolyte-containing composition prepared according to a conventional method. The drying of the inorganic solid electrolyte-containing composition may be carried out by being subjected to a drying treatment after the application or may be carried out by being subjected to a drying treatment collectively after the multiple layer application.

It is preferable that in a case where the solid electrolyte sheet for an all-solid state secondary battery according to the embodiment of the present invention is used, it is used generally by peeling off the base material, and in a case where the electrode sheet for an all-solid state secondary battery according to the embodiment of the present invention is used, a laminate of the base material and the active material layer is used as an electrode.

As the manufacturing method for an all-solid state secondary battery, for example, onto a positive electrode collector as a base material, an inorganic solid electrolyte-containing composition containing a positive electrode active material is applied and dried as a material for a positive electrode (a positive electrode composition) to form a positive electrode active material layer, thereby producing a positive electrode sheet for an all-solid state secondary battery. Next, the inorganic solid electrolyte-containing composition for forming a solid electrolyte layer is applied and dried onto the positive electrode active material layer to form the solid electrolyte layer. Furthermore, an inorganic solid electrolyte-containing composition containing a negative electrode active material is applied and dried as a material for a negative electrode (a negative electrode composition) onto the solid electrolyte layer, to form a negative electrode active material layer. A negative electrode collector (a metal foil) is superposed on the negative electrode active material layer, whereby it is possible to obtain an all-solid state secondary battery having a structure in which the solid electrolyte layer is sandwiched between the positive electrode active material layer and the negative electrode active material layer.

In addition, it is also possible to manufacture an all-solid state secondary battery by carrying out the forming method for each layer in reverse order to form a negative electrode active material layer, a solid electrolyte layer, and a positive electrode active material layer on a negative electrode collector as a base material and superposing a positive electrode collector thereon.

Examples of the other method include the following method. That is, the positive electrode sheet for an all-solid state secondary battery is produced as described above. Further, in the same manner, a negative electrode sheet for an all-solid state secondary battery, having a negative electrode active material layer on the negative electrode collector, is produced. Next, a solid electrolyte layer is formed on the active material layer in any one of these sheets as described above. Furthermore, the other one of the positive electrode sheet for an all-solid state secondary battery and the negative electrode sheet for an all-solid state secondary battery is laminated on the solid electrolyte layer such that the solid electrolyte layer and the active material layer come into contact with each other. In this manner, an all-solid state secondary battery can be manufactured.

Further, examples of the other method include the following method. That is, a positive electrode sheet for an all-solid state secondary battery and a negative electrode sheet for an all-solid state secondary battery are produced as described above. In addition, separately from the positive electrode sheet for an all-solid state secondary battery and the negative electrode sheet for an all-solid state secondary battery, an inorganic solid electrolyte-containing composition is applied onto a base material, thereby producing a solid electrolyte sheet for an all-solid state secondary battery consisting of a solid electrolyte layer. Furthermore, the positive electrode sheet for an all-solid state secondary battery and the negative electrode sheet for an all-solid state secondary battery are laminated with each other to sandwich the solid electrolyte layer that has been peeled off from the base material. In this manner, an all-solid state secondary battery can be manufactured. In this method, it is possible to use the electrode sheet manufactured by the sheet manufacturing method according to the embodiment of the present invention and a solid electrolyte sheet for an all-solid state secondary battery for any one of the negative electrode, the solid electrolyte layer, or the positive electrode, which is preferable from the viewpoint that it is possible to manufacture an all-solid state secondary battery having a preferred form while imparting higher cycle characteristics.

Further, a positive electrode sheet for an all-solid state secondary battery, a negative electrode sheet for an all-solid state secondary battery, and a solid electrolyte sheet for an all-solid state secondary battery are produced as described above. Next, the positive electrode sheet for an all-solid state secondary battery or negative electrode sheet for an all-solid state secondary battery, and the solid electrolyte sheet for an all-solid state secondary battery are overlaid and pressurized into a state where the positive electrode active material layer or the negative electrode active material layer is brought into contact with the solid electrolyte layer. In this manner, the solid electrolyte layer is transferred to the positive electrode sheet for an all-solid state secondary battery or the negative electrode sheet for an all-solid state secondary battery. Then, the solid electrolyte layer from which the base material of the solid electrolyte sheet for an all-solid state secondary battery has been peeled off and the negative electrode sheet for an all-solid state secondary battery or positive electrode sheet for an all-solid state secondary battery are overlaid and pressurized (into a state where the negative electrode active material layer or positive electrode active material layer is brought into contact with the solid electrolyte layer). In this manner, an all-solid state secondary battery can be manufactured. The pressurizing method and the pressurizing conditions in this method are not particularly limited, and a method and pressurizing conditions described in the pressurization step, which will be described later, can be applied.

The solid electrolyte layer or the like can also be formed on the base material or the active material layer, for example, by pressure-molding the inorganic solid electrolyte-containing composition or the like under the conditions described in the pressurization step described below, or the solid electrolyte or a sheet molded body of the active material.

(Pressurization Step)

After applying the inorganic solid electrolyte-containing composition, it is preferable to pressurize each layer or the all-solid state secondary battery after superimposing the constitutional layers or producing the all-solid state secondary battery. In addition, each of the layers is also preferably pressurized together in a state of being laminated. As the pressurizing method and the pressurizing condition, the pressurizing method and the pressurizing condition for the coated and dried layer can be applied without particular limitation. It is noted that in a case of pressurizing the all-solid state secondary battery, it is also possible to use a restraining device of the all-solid state secondary battery (the screw fastening pressure or the like) in order to continuously apply an intermediate pressure. The heating temperature in a case of carrying out heating and pressurization at the same time is not particularly limited, and it is generally set in a range of 30° C. to 300° C.

(Initialization)

The all-solid state secondary battery manufactured as described above is preferably initialized after the manufacturing or before use. The initialization is not particularly limited, and it is possible to initialize the all-solid state secondary battery by, for example, carrying out initial charging and discharging in a state where the pressing pressure is increased and then releasing the pressure up to a pressure at which the all-solid state secondary battery is ordinarily used.

### EXAMPLES

Hereinafter, the present invention will be described in more detail based on Examples; however, the present invention is not limited thereto be interpreted. “Parts” and “%” that represent compositions in the following Examples are based on the mass unless particularly otherwise described. In the present invention, “room temperature” means 25° C.

1. Synthesis of Fluorine-Containing Polymer SP-1 and Preparation of Binder Solution SP-1

### Preparation Example 1

A fluorine-containing polymer SP-1 was synthesized to prepare a binder solution SP-1 (concentration: 10% by mass) consisting of the fluorine-containing polymer.

Specifically, 200 parts by mass of ion exchange water, 120 parts by mass of vinylidene fluoride (VDF), and 80 parts by mass of hexafluoropropylene (HFP) were added to the autoclave, and further 1 part by mass of diisopropyl peroxydicarbonate was added thereto, followed by stirring at 30° C. for 24 hours. After completion of the polymerization reaction, the precipitate was filtered and dried at 100° C. for 10 hours to obtain a fluorine-containing polymer (a binder) SP-1. The obtained polymer (VDF:HFP (molar ratio)=78:22) was a random copolymer, and the mass average molecular weight thereof was 1,100,000. This fluorine-containing polymer SP-1 was dissolved in butyl butyrate to obtain a binder solution SP-1.

2. Synthesis of Sulfide-Based Inorganic Solid Electrolyte

### Synthesis Example A

A sulfide-based inorganic solid electrolyte was synthesized with reference to a non-patent document of T. Ohtomo, A. Hayashi, M. Tatsumisago, Y. Tsuchida, S. Hama, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a globe box in an argon atmosphere (dew point: −70° C.), lithium sulfide (Li₂S, manufactured by Sigma-Aldrich Co., LLC Co., LLC Co., LLC, purity: >99.98%) (2.42 g) and diphosphorus pentasulfide (P₂S₅, manufactured by Sigma-Aldrich Co., LLC Co., LLC Co., LLC, purity: >99%) (3.90 g) each were weighed, put into an agate mortar, and mixed using an agate pestle for five minutes. The mixing ratio between Li₂S and P₂S₅ (Li₂S:P₂S₅) was set to 75:25 in terms of molar ratio.

Next, 66 g of zirconia beads having a diameter of 5 mm were put into a 45 mL container made of zirconia (manufactured by FRITSCH), the entire amount of the mixture of the above lithium sulfide and the diphosphorus pentasulfide was put thereinto, and the container was completely sealed in an argon atmosphere. The container was set in a planetary ball mill P-7 (product name, manufactured by FRITSCH), mechanical milling was carried out at a temperature of 25° C. and a rotation speed of 510 rpm for 36 hours, thereby obtaining yellow powder (6.20 g) of a sulfide-based inorganic solid electrolyte (Li—P—S-based glass, hereinafter, may be referred to as LPS). The particle diameter of the Li—P—S-based glass was 4 μm.

### Example 1

<Preparation of Inorganic Solid Electrolyte-Containing Compositions S-1 to S-5>

2.8 g of the LPS synthesized in Synthesis Example A, 0.08 g of the binder solution SP-1 prepared in Preparation Example 1 (in terms of solid content mass), and butyl butyrate as a dispersion medium were put into a container for a self-rotation type mixer ARE-310 (product name, manufactured by THINKY CORPORATION) so that the solid content concentration in the composition was “Solid content concentration” shown in Table 1. Then, this container was set in the self-rotation type mixer ARE-310, and mixing was carried out for 5 minutes under the conditions of “Preparation temperature” shown in Table 1 and the rotation speed of 2,000 rpm to prepare each of inorganic solid electrolyte-containing compositions (slurries) S-1 to S-5. It is noted that in a case where the preparation temperature was 45° C. or 100° C., heating was carried out (for 20 minutes) with stirring at a predetermined temperature using a hot plate stirrer PC-420D (product name, manufactured by TAITEC CORPORATION) in an argon atmosphere, and then the container was set in a self-rotation type mixer and mixed (the same applies hereinafter).

The contents of the respective components in the composition were 97.2% by mass for LPS and 2.8% by mass for the binder in 100% by mass of the solid content.

<Preparation of Positive Electrode Compositions P-1 to P-5>

2.8 g of LPS synthesized in Synthesis Example A and butyl butyrate as a dispersion medium were put into a container for a self-rotation type mixer ARE-310 so that the solid content concentration in the composition was “Solid content concentration” shown in Table 1. Then, this container was set in the self-rotation type mixer ARE-310 and, mixing was carried out for 2 minutes under the conditions of “Preparation temperature” shown in Table 1 and the rotation speed of 2,000 rpm. Then, 13.2 g of LiNi_{1/3}ComMn_{1/3}O₂ (NMC, manufactured by Sigma-Aldrich Co., LLC) as a positive electrode active material, 0.32 g of acetylene black (AB) as a conductive auxiliary agent, and 0.16 g (in terms of solid content mass) of the binder solution SP-1 prepared in Preparation Example 1 were put into this container, and the container was set in the self-rotation type mixer ARE-310 and, mixing was further carried out for 2 minutes under the conditions of “Preparation temperature” shown in Table 1 and the rotation speed of 2,000 rpm to prepare each of positive electrode compositions (slurries) P-1 to P-5.

The contents of the respective components in the composition were 17.0% by mass for LPS, 80.1% by mass for NMC, 1.0% by mass for the binder, and 1.9% by mass for AB in 100% by mass of the solid content.

<Preparation of Negative Electrode Composition N-1 to N-12>

2.8 g of the LPS synthesized in Synthesis Example A, 0.08 g of the binder solution SP-1 prepared in Preparation Example 1 (in terms of solid content mass), and “Dispersion medium” shown in Table 1 were put into a container for the self-rotation type mixer ARE-310 so that the solid content concentration in the composition was “Solid content concentration” shown in Table 1. Then, this container was set in the self-rotation type mixer ARE-310 and, mixing was carried out for 2 minutes under the conditions of “Preparation temperature” shown in Table 1 and the rotation speed of 2,000 rpm. Then, 3.53 g of silicon (Si, manufactured by Sigma-Aldrich Co., LLC) as a negative electrode active material and 0.27 g of carbon nanotube VGCF (product name, manufactured by Showa Denko Co., Ltd.) as a conductive auxiliary agent were put into the container, the container was set in the same manner in the self-rotation type mixer ARE-310 and, mixing was further carried out for 2 minutes under the conditions of “Preparation temperature” shown in Table 1 and the rotation speed of 2,000 rpm to prepare each of negative electrode compositions (slurries) N-1 to N-12.

The contents of the respective components in the composition were 42.0% by mass for LPS, 52.8% by mass for Si, 1.2% by mass for the binder 1, and 4.0% by mass for VGCF in 100% by mass of the solid content. However, the contents of the respective components of the composition N-2 were 42.4% by mass for LPS, 53.5% by mass for Si, and 4.1% by mass for VGCF in 100% by mass of the solid content.

For each of the prepared compositions, the viscosities at 25° C., the preparation temperature, and the application temperature in the manufacture of each sheet described later were measured according to the following method. In addition, for each composition, the difference (the viscosity change width Δ (in terms of absolute value)) between the viscosity at 25° C. and the viscosity at a higher temperature among the preparation temperature and the application temperature was calculated. These results are shown in Table 1.

[Measurement of Viscosity of Composition]

Using an E-type viscometer (TV-35 type, manufactured by TOKI SANGYO Co., Ltd.) and a standard cone rotor (1° 34′×R24), 1.1 mL of a sample (a composition) was applied to a sample cup adjusted to a predetermined measurement temperature, set in the main body, and maintained for 5 minutes until the temperature became constant. Then, the measurement range was set to “U”, and a value obtained by measuring at a shear rate of 10/s (rotation speed: 2.5 rpm) one minute after the start of rotation was defined as the viscosity.

TABLE 1

| | | | | | | | | All-solid | | |
|---|---|---|---|---|---|---|---|---|---|---|
| | | | | | | | | state secondary battery | | |
| | | | | | | | | Application | | |
| | Inorganic solid electrolyte-containing composition (electrode composition) | | | | | | | temperature | | |
| | Dispersion medium | | | | | Viscosity at | | (temperature | Viscosity at | |
| | | Boiling | | Solid content | Preparation | preparation | Viscosity | before film | application | Viscosity |
| | | point | | composition | temperature | temperature | at 25° C. | formation) | temperature | change width |
| No. | | (° C.) | Binder | (% by mass) | (° C.) | (cP) | (cP) | (° C.) | (cP) | Δ (cP) |
| N-1 | Butyl butyrate | 166 | Contained | 71 | 45 | 1000 | 5000 | 45 | 1000 | 4000 |
| N-2 | Butyl butyrate | 166 | Not | 71 | 45 | 800 | 4500 | 45 | 800 | 3700 |
| | | | contained | | | | | | | |
| N-3 | Butyl butyrate | 166 | Contained | 71 | 25 | 5000 | 5000 | 45 | 1000 | 4000 |
| N-4 | Heptane | 98 | Contained | 71 | 25 | 5000 | 5000 | 45 | 1500 | 3500 |
| N-5 | Ethyl butyrate | 120 | Contained | 71 | 25 | 5000 | 5000 | 45 | 1200 | 3800 |
| N-6 | Pentyl pentanoate | 207 | Contained | 71 | 25 | 5000 | 5000 | 45 | 1000 | 4000 |
| N-7 | Kerosine | 240 | Contained | 71 | 25 | 5000 | 5000 | 45 | 1800 | 3200 |
| N-8 | Butyl butyrate | 166 | Contained | 71 | 45 | 1000 | 5000 | 25 | 5000 | 4000 |
| N-9 | Butyl butyrate | 166 | Contained | 65 | 45 | 450 | 1000 | 25 | 1000 | 550 |
| N-10 | Butyl butyrate | 166 | Contained | 71 | 25 | 5000 | 5000 | 25 | 5000 | 0 |
| N-11 | Butyl butyrate | 166 | Contained | 65 | 25 | 1000 | 1000 | 25 | 1000 | 0 |
| N-12 | Butyl butyrate | 166 | Contained | 71 | 100 | 400 | 4800 | 100 | 400 | 4400 |
| S-1 | Butyl butyrate | 166 | Contained | 68 | 45 | 1000 | 5000 | 45 | 1000 | 4000 |
| S-2 | Butyl butyrate | 166 | Contained | 68 | 25 | 5000 | 5000 | 45 | 1000 | 4000 |
| S-3 | Butyl butyrate | 166 | Contained | 68 | 45 | 1000 | 5000 | 25 | 5000 | 4000 |
| S-4 | Butyl butyrate | 166 | Contained | 68 | 25 | 5000 | 5000 | 25 | 5000 | 0 |
| S-5 | Butyl butyrate | 166 | Contained | 63 | 25 | 1000 | 1000 | 25 | 1000 | 0 |
| P-1 | Butyl butyrate | 166 | Contained | 65 | 45 | 1000 | 5000 | 45 | 1000 | 4000 |
| P-2 | Butyl butyrate | 166 | Contained | 65 | 25 | 5000 | 5000 | 45 | 1000 | 4000 |
| P-3 | Butyl butyrate | 166 | Contained | 65 | 45 | 1000 | 5000 | 25 | 5000 | 4000 |
| P-4 | Butyl butyrate | 166 | Contained | 65 | 25 | 5000 | 5000 | 25 | 5000 | 0 |
| P-5 | Butyl butyrate | 166 | Contained | 66 | 25 | 1000 | 1000 | 25 | 1000 | 0 |

<Manufacture of Solid Electrolyte Sheets S-1 to S-5 for all-Solid State Secondary Battery>

The temperature of each of the inorganic solid electrolyte-containing compositions S-1 to S-5 obtained as described above was set to “Application temperature” (the temperature before the film formation) shown in Table 1. Specifically, regarding S-1 and S-2 in which the “application temperature” is higher than room temperature, each composition was heated (for 20 minutes) with stirring by using a hot plate stirrer PC-420D (product name, manufactured by TAITEC CORPORATION) in an argon atmosphere to set to a predetermined application temperature.

Each inorganic solid electrolyte-containing composition set to the application temperature in this way was applied onto an aluminum foil (non-heated: 25° C.) having a thickness of 20 μm by using a baker type applicator (product name: SA-201, manufactured by Tester Sangyo Co., Ltd.) (for about 1 hour from the preparation to the start of the application and about 20 minutes from the setting of the application temperature to the start of the application). The applied inorganic solid electrolyte-containing composition was heated at 110° C. for 2 hours and dried (the dispersion medium was removed). Then, using a heat press machine, the dried inorganic solid electrolyte-containing composition was pressurized at 25° C. (10 MPa for 10 seconds) to form a film of the inorganic solid electrolyte-containing composition (the thickness of the solid electrolyte layer: 50 μm). In this way, each of solid electrolyte sheets S-1 to S-5 for an all-solid state secondary battery was manufactured.

<Manufacture of Positive Electrode Sheets P-1 to P-5 for all-Solid State Secondary Battery>

The temperature of each of the positive electrode compositions P-1 to P-5 obtained as described above was set to “Application temperature” shown in Table 1 in the same manner as in the above-described inorganic solid electrolyte-containing composition. Each of the positive electrode compositions P-1 to P-5 set to the application temperature in this way was applied onto an aluminum foil (non-heated: 25° C.) having a thickness of 20 μm by using a baker type applicator (product name: SA-201) (for about 1 hour from the preparation to the start of the application and about 20 minutes from the setting of the application temperature to the start of the application). The applied positive electrode composition was heated at 110° C. for 1 hour and dried (the dispersion medium was removed). Then, using a heat press machine, the dried positive electrode composition was pressurized at 25° C. (10 MPa, 1 minute) to form a film of the positive electrode composition (the thickness of the positive electrode active material layer: 100 μm). In this way, each of positive electrode sheets P-1 to P-5 for an all-solid state secondary battery was manufactured.

<Manufacture of Negative Electrode Sheets N-1 to N-12 for all-Solid State Secondary Battery>

The temperature of each of the negative electrode compositions N-1 to N-12 obtained as described above was set to “Application temperature” shown in Table 1 in the same manner as in the above-described inorganic solid electrolyte-containing composition. Each of the negative electrode compositions set to the application temperature in this way was applied onto a copper foil (non-heated: 25° C.) having a thickness of 20 μm by using a baker type applicator (product name: SA-201) (for about 1 hour from the preparation to the start of the application and about 20 minutes from the setting of the application temperature to the start of the application). The applied negative electrode composition was heated at 110° C. for 1 hour, and then, it was further dried and heated at 110° C. for 2 hours with a vacuum dryer AVO-200NS (product name, manufactured by AS ONE Corporation) to dry (remove the dispersion medium). Then, using a heat press machine, the dried negative electrode composition was pressurized at 25° C. (10 MPa, 1 minute) to form a film of the negative electrode composition (the thickness of the negative electrode active material layer: 70 μm). In this way, each of negative electrode sheets N-1 to N-12 for an all-solid state secondary battery was manufactured.

The following evaluations were carried out for each of the manufactured compositions and each of the sheet, and the results are shown in Table 2.

<Evaluation 1: Dispersion Characteristics (Dispersibility)>

A composition (a composition after being set to the application temperature shown in Table 1) at the time of applying onto a base material in the above-described manufacturing method for each sheet was sampled, and the following dispersibility test was carried out.

Each sampled composition (slurry) was dropped in a groove of a particle size measuring device (a grind meter) 232/III type (product name, manufactured by AS ONE Corporation), and a value obtained by reading, according to the gradation, the position of the line that appeared after scraping with a scraper was defined as the aggregation size X. On the other hand, the aggregation size X0 of the composition in which the viscosity was adjusted to 300 cP was measured in the same manner as the aggregation size X. The aggregation size ratio [X/X0] was calculated using the obtained aggregation sizes X and X0.

The ease of aggregation of solid particles was evaluated as the dispersibility of the composition by determining where this aggregation size ratio [X/X0] is included in any one of the following evaluation standards.

In this test, the smaller the aggregation size ratio [X/X0] is, the less the solid particles are aggregated or sedimented, which indicates that the dispersibility is excellent, and an evaluation standard “F” or higher is the pass level.

It is noted that although the inorganic solid electrolyte-containing composition N-10 is included in the evaluation standard “G”, the aggregation size ratio [X/X0] is 2.0.

—Evaluation Standards—

A: X/X0<1.1

B: 1.1≤X/X0<1.2

C: 1.2≤X/X0<1.3

D: 1.3≤X/X0<1.4

E: 1.4≤X/X0<1.5

F: 1.5≤X/X0<1.6

G: 1.6≤X/X0

<Evaluation 2: Dispersion Characteristics (Stability)>

A composition (a composition after being set to the application temperature shown in Table 1) at the time of applying onto a base material in the above-described manufacturing method for each sheet was sampled, and the following dispersion stability test was carried out.

Each of the sampled compositions (slurries) was put into a glass test tube having a diameter of 10 mm and a height of 4 cm up to a height of 4 cm and allowed to stand at 25° C. for 24 hours. The solid content reduction rate for the upper 30% (in terms of height) of the composition before and after standing was calculated from the following expression. The ease of sedimentation (precipitation) of the solid particles due to a lapse of time was evaluated as the dispersion stability (the storage stability) of the composition by determining where the solid content reduction rate is included in any one of the following evaluation standards. In this test, the smaller the solid content reduction rate, the better the dispersion stability, and the evaluation standard “F” or higher is the pass level.

Solid content reduction rate (%)=[(solid content concentration of upper 30% before standing-solid content concentration of upper 30% after standing)/solid content concentration of upper 30% before standing]×100

—Evaluation Standards—

A: Solid content reduction rate<1%

B: 1%≤solid content reduction rate<3%

C: 3%≤solid content reduction rate<5%

D: 5%≤solid content reduction rate<7%

E: 7%≤solid content reduction rate<9%

F: 9%≤solid content reduction rate<11%

G: 11%≤solid content reduction rate

<Evaluation 3: Application Suitability (Flatness)>

As the application suitability of each composition, the maximum height roughness Rz of the surface of the solid electrolyte layer or the surface of the active material layer of each obtained sheet was measured and evaluated.

Specifically, the maximum height roughness Rz of the surface of the solid electrolyte layer or the surface of the active material layer of each sheet was measured with the following measuring device and under the following conditions according to Japanese Industrial Standards (JIS) B 0601: 2013.

The ease of forming a constitutional layer having a flat surface and good surface properties (the flatness) was evaluated as the application suitability of the composition, by determining where the maximum height roughness Rz is included in any of the following evaluation standards. In this test, the smaller the maximum height roughness Rz is, the more excellent the application suitability (the flatness) is, and an evaluation standard “F” or higher is the pass level.

It is noted that although the inorganic solid electrolyte-containing composition N-10 is included in the evaluation standard “G”, the maximum height roughness Rz is 15 μm.

—Measuring Device and Conditions—

Measuring device: Three-dimensional fine shape measuring instrument (model: ET-4000A, product name, manufactured by Kosaka Laboratory Ltd.)

Analytical instrument: 3D surface roughness analysis system (model TDA-31)

Touch needle: Tip radius of 0.5 μmR, diameter of 2 μm, made of diamond

Needle pressure: 1 μN

Measurement length: 5.0 mm

Measurement speed: 0.02 mm/s

Measurement interval: 0.62 μm

Cutoff: Absent

Filter method: Gaussian spatial type

Leveling: Present (quadratic curve)

—Evaluation Standards—

A: Rz<1.0 μm

B: 1.0 μm≤Rz<2.0 μm

C: 2.0 μm≤Rz<4.0 μm

D: 4.0 μm≤Rz<6.0 μm

E: 6.0 μm≤Rz<8.0 μm

F: 8.0 μm≤Rz<10 μm

G: 10 μm≤Rz

<Evaluation 4: Application Suitability (Adhesiveness)>

As the application suitability of each composition, the adhesiveness of the solid particles in the solid electrolyte layer or active material layer of each obtained sheet and the adhesiveness between the active material layer and the collector were evaluated.

The prepared sheet was cut out into a rectangle having a width of 3 cm and a length of 14 cm. Using a cylindrical mandrel tester (product code: 056, mandrel diameter: 10 mm, manufactured by Allgood Co., Ltd.), one end part of the cut-out sheet test piece in the length direction was fixed to the tester and disposed so that the cylindrical mandrel touched to the central portion of the sheet test piece, and then the sheet test piece was bent by 180° along the peripheral surface of the mandrel (with the mandrel as an axis) while pulling the other end part of the sheet test piece in the length direction with a force of 5N along the length direction. It is noted that the sheet test piece was set so that the solid electrolyte layer or active material layer thereof was placed on a side opposite to the mandrel (the base material or the collector was placed on the side of the mandrel) and the width direction was parallel to the axis line of the mandrel. The test was carried out by gradually reducing the diameter of the mandrel from 32 mm.

In a state of being wound around the mandrel and a state of being restored to a sheet shape by releasing the winding, the occurrence of defects (cracking, breakage, chipping, and the like) due to the disintegration of binding of solid particles in the solid electrolyte layer or the active material layer and for the active material layer, the minimum diameter at which the peeling between the active material layer and the collector could not be confirmed were measured, and the evaluation was carried out by determining which evaluation standard below is satisfied by the minimum diameter.

In this test, it is indicated that the smaller the minimum diameter is, the more firm the binding force of the solid particles that constitute the solid electrolyte layer or active material layer is, and the more firm the adhesion between the active material layer and the collector is, and an evaluation standard “F” or higher is the pass level.

It is noted that although the inorganic solid electrolyte-containing composition N-10 is included in the evaluation standard “G”, the minimum diameter is 32 mm.

—Evaluation Standards—

A: Minimum diameter<5 mm

B: 5 mm≤minimum diameter<6 mm

C: 6 mm≤minimum diameter<8 mm

D: 8 mm≤minimum diameter<10 mm

E: 10 mm≤minimum diameter<14 mm

F: 14 mm≤minimum diameter<25 mm

G: 25 mm≤minimum diameter

TABLE 2

| | Evaluation | | | | |
|---|---|---|---|---|---|
| | Dispersion | | Application | | |
| | characteristics | | suitability | | |
| | Disper- | Stabil- | Flat- | Adhe- | |
| No. | sibility | ity | ness | siveness | Note |
| N-1 | A | A | A | A | Present invention |
| N-2 | C | B | C | C | Present invention |
| N-3 | E | E | A | A | Present invention |
| N-4 | F | F | F | F | Present invention |
| N-5 | E | E | A | A | Present invention |
| N-6 | E | E | B | B | Present invention |
| N-7 | F | F | F | F | Present invention |
| N-8 | C | C | E | E | Present invention |
| N-9 | E | F | C | C | Present invention |
| N-10 | G | E | G | G | Comparative |
| | | | | | Example |
| N-11 | F | G | D | D | Comparative |
| | | | | | Example |
| N-12 | G | F | G | G | Comparative |
| | | | | | Example |
| S-1 | A | A | A | A | Present invention |
| S-2 | E | E | A | A | Present invention |
| S-3 | C | C | E | E | Present invention |
| S-4 | G | E | G | G | Comparative |
| | | | | | Example |
| S-5 | F | G | D | D | Comparative |
| | | | | | Example |
| P-1 | A | A | A | A | Present invention |
| P-2 | E | E | A | A | Present invention |
| P-3 | C | C | E | E | Present invention |
| P-4 | G | E | G | G | Comparative |
| | | | | | Example |
| P-5 | F | G | D | D | Comparative |
| | | | | | Example |

<Manufacture of All-Solid State Secondary Batteries C-1 to C-5>

A positive electrode sheet for an all-solid state secondary battery, a solid electrolyte sheet for an all-solid state secondary battery, and a negative electrode sheet for an all-solid state secondary battery were used in combinations of the constitutional layers shown in Table 3 to manufacture all-solid state secondary battery.

The positive electrode sheet P-1 or P-4 for an all-solid state secondary battery was punched out into a disk shape having a diameter of 10 mm and was placed in a cylinder made of PET having an inner diameter of 10 mm. Each of the solid electrolyte sheet S-1 or S-4 for an all-solid state secondary battery were punched on the side of the positive electrode active material layer in the cylinder into a disk shape having a diameter of 10 mm and placed in the cylinder, and a 10 mm stainless steel (SUS) rod was inserted from the openings at both ends of the cylinder. The collector side of the positive electrode sheet for an all-solid state secondary battery and the aluminum foil side of the solid electrolyte sheet for an all-solid state secondary battery were pressurized by applying a pressure of 350 MPa with a SUS rod. Then, the SUS rod on the side of the solid electrolyte sheet for an all-solid state secondary battery was temporarily removed, and the aluminum foil of the solid electrolyte sheet for an all-solid state secondary battery was gently peeled off. Next, the negative electrode sheet N-1 or N-10 for an all-solid state secondary battery was punched out into a disk shape having a diameter of 10 mm and inserted onto the solid electrolyte layer of the solid electrolyte sheet for an all-solid state secondary battery in the cylinder. The removed SUS rod was inserted again into the cylinder and the sheets were fixed while applying a pressure of 50 MPa. In this way, all-solid state secondary battery Nos. C-1 to C-5 having a structure of an aluminum foil (thickness: 20 μm)-a positive electrode active material layer (thickness: 90 μm)-a solid electrolyte layer (thickness: 45 μm)-a negative electrode active material layer (thickness: 65 μm)-a copper foil (thickness: 20 μm) were obtained.

<Evaluation 5: Cycle Characteristics>

The discharge capacity retention rate of each of the all-solid state secondary batteries manufactured as described above was measured using a charging and discharging evaluation device TOSCAT-3000 (product name, manufactured by Toyo System Corporation).

Specifically, each of the all-solid state secondary batteries was charged in an environment of 25° C. at a current density of 0.1 mA/cm² until the battery voltage reached 3.6 V. Then, the battery was discharged at a current density of 0.1 mA/cm² until the battery voltage reached 2.5 V. One charging operation and one discharging operation were set as one cycle of initialization charging and discharging, and 3 cycles of initialization charging and discharging were repeated under the same conditions to carry out initialization. Then, under the same conditions as the cycle of initialization charging and discharging, charging and discharging were repeatedly carried out for 1,000 cycles, and the discharge capacity at the first cycle of charging and discharging and the discharge capacity at the 1,000th cycle thereof were determined with a charging and discharging evaluation device: TOSCAT-3000 (product name). The discharge capacity retention rate was calculated according to the following expression, and this discharge capacity retention rate was applied to the following evaluation standards to evaluate the cycle characteristics of the all-solid state secondary battery. In this test, the higher the evaluation standard is, the better the battery performance (the cycle characteristics) is, and the initial battery performance can be maintained even in a case where a plurality of times of charging and discharging are repeated (even in a case of the long-term use). In this test, an evaluation standard of “F” or higher is the pass level.

All of the all-solid state secondary batteries according to the embodiment of the present invention exhibited initial discharge capacity values sufficient for functioning as an all-solid state secondary battery.

Discharge capacity retention rate (%)=(discharge capacity at 1,000th cycle/discharge capacity at first cycle)×100

—Evaluation Standards—

A: 90%≤discharge capacity retention rate

B: 85%≤discharge capacity retention rate<90%

C: 80%≤discharge capacity retention rate<85%

D: 75%≤discharge capacity retention rate<80%

E: 70%≤discharge capacity retention rate<75%

F: 60%≤discharge capacity retention rate<70%

G: Discharge capacity retention rate<60%

TABLE 3

| | Negative | Solid | Positive | | |
|---|---|---|---|---|---|
| | electrode | electro- | electrode | Cycle | |
| Battery | active | lyte | active | character- | |
| No. | material | layer | material | istics | Note |
| C-1 | N-1 | S-1 | P-1 | A | Present invention |
| C-2 | N-1 | S-4 | P-4 | D | Present invention |
| C-3 | N-10 | S-1 | P-4 | E | Present invention |
| C-4 | N-10 | S-4 | P-1 | D | Present invention |
| C-5 | N-10 | S-4 | P-4 | G | Comparative |
| | | | | | Example |

The following findings can be seen from the results of Table 2 and Table 3.

In the manufacture of the sheet for an all-solid state secondary battery, the inorganic solid electrolyte-containing composition in which both the preparation temperature and the application temperature are not adjusted and set to room temperature, and the inorganic solid electrolyte-containing composition in which both the preparation temperature and the application temperature are set to 100° C. are inferior in any one of dispersibility or stability, and furthermore, they are inferior in application suitability as well. As a result, it is not possible to manufacture (realize) an all-solid state secondary battery that exhibits sufficient cycle characteristics even in a case of using a sheet for an all-solid state secondary battery, manufactured by using such an inorganic solid electrolyte-containing composition.

On the other hand, in the manufacture of the sheet for an all-solid state secondary battery, the inorganic solid electrolyte-containing composition in which any one or both of the preparation temperature and the application temperature is set to 45° C. has improved dispersion characteristics (dispersibility and stability) and improved application suitability (flatness and adhesiveness). In particular, the inorganic solid electrolyte-containing composition in which both the preparation temperature and the application temperature are set to 45° C. exhibits excellent dispersion characteristics and application suitability in a well-balanced manner. In addition, from the comparison with Comparative Examples (for example, N-10 and N-11) in which the application temperature is not set to the predetermined temperature and is heated to a temperature range of 35° C. to 90° C. at the time of drying after being applied on onto the base material, it can be seen that in a case of setting the application temperature of the inorganic solid electrolyte-containing composition to be used, to the predetermined temperature, it is possible to significantly improve the application suitability in addition to the dispersion characteristics of the composition. According to the present invention, it is possible to realize such excellent dispersion characteristics and application suitability even in a case of setting the solid content concentration of the inorganic solid electrolyte-containing composition to a high concentration of 65% by mass or more. As a result, in a case of using a sheet for an all-solid state secondary battery manufactured by using an inorganic solid electrolyte-containing composition in which any one or both of the preparation temperature and the application temperature is set, it is possible to manufacture (realize) an all-solid state secondary battery that exhibits excellent cycle characteristics.

The present invention has been described together with the embodiments of the present invention. However, the inventors of the present invention do not intend to limit the present invention in any part of the details of the description unless otherwise designated, and it is conceived that the present invention should be broadly construed without departing from the spirit and scope of the invention shown in the attached “WHAT IS CLAIMED IS”.

This application claims priority based on JP2020-114680 filed in Japan on Jul. 2, 2020, which is incorporated herein by reference as a part of the description of the present specification.

### EXPLANATION OF REFERENCES

1: negative electrode collector
2: negative electrode active material layer
3: solid electrolyte layer
4: positive electrode active material layer
5: positive electrode collector
6: operation portion
10: all-solid state secondary battery

What is claimed is:

1. A manufacturing method for a sheet for an all-solid state secondary battery, comprising:
subjecting an inorganic solid electrolyte-containing composition containing an inorganic solid electrolyte having an ion conductivity of a metal belonging to Group 1 or Group 2 in the periodic table and a dispersion medium, to application and film formation onto a base material,
wherein in the inorganic solid electrolyte-containing composition, any one or both of a preparation temperature and a temperature before the application and the film formation is set to 35° C. to 90° C.

2. The manufacturing method for a sheet for an all-solid state secondary battery according to claim 1,
wherein both of the preparation temperature and the temperature before the application and the film formation are set to 35° C. to 90° C.

3. The manufacturing method for a sheet for an all-solid state secondary battery according to claim 1,
wherein the inorganic solid electrolyte-containing composition has a viscosity of 500 to 10,000 cP at 25° C.

4. The manufacturing method for a sheet for an all-solid state secondary battery according to claim 1,
wherein in the inorganic solid electrolyte-containing composition, a difference (in terms of absolute value) between the viscosity at 25° C. and a viscosity at a higher temperature among the preparation temperature and the temperature before the application and the film formation is 1,000 cP or more.

5. The manufacturing method for a sheet for an all-solid state secondary battery according to claim 1,
wherein the dispersion medium has a boiling point of 100° C. to 250° C.

6. The manufacturing method for a sheet for an all-solid state secondary battery according to claim 1,
wherein the inorganic solid electrolyte-containing composition contains a binder.

7. The manufacturing method for a sheet for an all-solid state secondary battery according to claim 1,
wherein the inorganic solid electrolyte-containing composition contains an active material.

8. A manufacturing method for an all-solid state secondary battery which has a positive electrode active material layer, a solid electrolyte layer, and a negative electrode active material layer in this order, the manufacturing method for an all-solid state secondary battery, comprising:
a step of manufacturing at least one layer of the positive electrode active material layer, the solid electrolyte layer, or the negative electrode active material layer by the manufacturing method for a sheet for an all-solid state secondary battery according to claim 1.

9. The manufacturing method for an all-solid state secondary battery according to claim 8 which has a collector laminated on a side each of the positive electrode active material layer and the negative electrode active material layer, opposite to the solid electrolyte layer, the manufacturing method for all-solid state secondary battery, comprising:
a step of manufacturing at least one of a positive electrode in which the collector and the positive electrode active material layer are laminated, the solid electrolyte layer, or a negative electrode in which the collector and the negative electrode active material layer are laminated, through the manufacturing method for a sheet for an all-solid state secondary battery according to claim 1.

10. A sheet for an all-solid state secondary battery, which is manufactured according to the manufacturing method for a sheet for an all-solid state secondary battery according to claim 1.

11. An all-solid state secondary battery comprising, in the following order:
a positive electrode active material layer;
a solid electrolyte layer; and
a negative electrode active material layer,
wherein at least one layer of the positive electrode active material layer, the solid electrolyte layer, or the negative electrode active material layer is composed of the sheet for an all-solid state secondary battery according to claim 10.

12. The all-solid state secondary battery according to claim 11, further comprising:
a collector laminated on a side each of the positive electrode active material layer and the negative electrode active material layer, opposite to the solid electrolyte layer,
wherein at least one of a positive electrode in which the collector and the positive electrode active material layer are laminated, the solid electrolyte layer, or a negative electrode in which the collector and the negative electrode active material layer are laminated is composed of the sheet for an all-solid state secondary battery according to claim 10.
